(19) United States
(12) Patent Application Publication
(10) Pub. No.: US 2011/0280988 A1
(43) Pub. Date: Nov. 17, 2011

(54) EXERCISE PERFORMANCE AND RECOVERY FORMULATIONS

(75) Inventor: John Ivy, Austin, TX (US)

(73) Assignee: GILMORE SPORTS II, LLC, San Marcos, TX (US)

(21) Appl. No.: 13/109,432

(22) Filed: May 17, 2011

Related U.S. Application Data
(63) Continuation-in-part of application No. 12/671,016, filed on Jan. 27, 2010.
(60) Provisional application No. 61/345,508, filed on May 17, 2010.
(60) Provisional application No. 60/952,303, filed on Jul. 27, 2007.
(60) Provisional application No. 60/954,060, filed on Aug. 6, 2007.
(60) Provisional application No. 60/970,068, filed on Sep. 5, 2007.
(60) Provisional application No. 60/970,297, filed on Sep. 6, 2007.
(60) Provisional application No. 60/971,852, filed on Sep. 12, 2007.

(51) Int. Cl. A23L 1/30; A23L 1/305; A23L 1/304; A23L 2/66; A23L 1/302

(52) U.S. Cl. 426/2; 426/648; 426/573; 426/590; 426/72; 426/74

(57) ABSTRACT

Several embodiments disclosed herein relate to endurance-enhancing formulations comprising an optimized balance of carbohydrates and protein for consumption before or during physical activity, such as exercise. In several embodiments, consumption of the formulation before or during activity enhances endurance. Other embodiments provide for recovery formulations comprising an optimized balance of carbohydrates and protein, to optimize recovery from exercise, stimulate muscle glycogen repletion, muscle tissue repair and protein synthesis, and enhance the rate of training adaptation.

### RELATED CASES

This application claims the benefit of U.S. Provisional Application Ser. No. 61/345,508, filed on May 17, 2010, and is a continuation in part of U.S. patent application Ser. No. 12/671,016, filed on Jan. 27, 2010, which is the United States National Phase under 35 U.S.C. §371 of International Application No. PCT/US2008/071238, filed on Jul. 25, 2008, which claims the benefit of U.S. Provisional Application Ser. Nos. 60/952,303, filed on Jul. 27, 2007; 60/954,060, filed on Aug. 6, 2007; 60/970,068, filed on Sep. 5, 2007; 60/970,297, filed on Sep. 6, 2007; and 60/971,852, filed on Sep. 12, 2007. The contents of all of the above applications are expressly incorporated in their entirety by reference herein.

### BACKGROUND

1. Field of the Invention

The present disclosure is related to exercise performance formulations and exercise recovery formulations which, in several embodiments are used as sports drinks to enhance endurance and decrease muscle recovery time, thereby improving performance. In several embodiments, the formulations disclosed herein optimize recovery from exercise, stimulate muscle glycogen repletion, tissue repair and protein synthesis, and enhance the rate of training adaptation.

2. Description of the Related Art

As exercise becomes a more mainstream part of many modern everyday lifestyles, and many occupations require physical exertion akin to exercise, the sports beverage market has experienced a great deal of growth. Several exercise drinks are currently marketed based on claims that ingestion of the drink will help individuals, particularly athletes, replenish electrolytes and other nutrients that may be depleted as a result of exercise. Based on their composition, many of these drinks provide immediate and acute boosts of energy. Often, such short bursts are accompanied by a subsequent fall in energy levels, potentially leaving the individual with inadequate energy to complete their exercise routine. Moreover, even one exercise session with inadequate hydration and/or nutrient replacement can lead to poor recovery and subsequent decreased quality of exercise and possibly injury or illness.

### SUMMARY

Prior to Applicant's invention, several references disclosed that “carbo-loading” prior to exercise was the most efficient way to stock muscles with fuel. However, Applicant has determined that insulin in the blood was more effective at carrying energy into the muscles if those muscles had recently been active. For those formulations that contained protein, higher ratios of carbohydrates to protein were emphasized. For example, formulations described in U.S. Pat. Nos. 6,207,638 and 6,989,171, hereby incorporated by reference, provide a formulation containing carbohydrates and proteins in a ratio of 2.8 to 4.2 parts of carbohydrate to 1.0 part of proteins. According to U.S. Pat. Nos. 6,207,638 and 6,989,171, a ratio of 4:1 (carbohydrate to protein), provides increased insulin stimulation and enhances the synthesis of muscle glycogen with no negative impact on rehydration following exercise. These references assert that the level of protein is critical, and that “[w]hen the carbohydrate to protein ratio is less than 2.8, the protein has an adverse effect on gastric emptying which would slow rehydration and glucose absorption during exercise.”

Until Applicant's invention, it had been unappreciated that a carbohydrate to protein ratio of less than 2.8 offers several advantages. Despite the express teaching away in the art of using a ratio of less than 2.8, Applicant has discovered that a carbohydrate to protein ratio of less than 2.8 is not only beneficial for both exercise performance and exercise recovery, but offers several benefits and advantages over formulations with higher ratios. Applicant has further discovered that several embodiments of the invention also offer several benefits and advantages over formulations with carbohydrates only.

Thus, in several embodiments of the present invention, formulations comprising an optimal carbohydrate-to-protein ratio are provided. According to several embodiments of the present invention, formulations that comprise a unique blend of carbohydrates and protein are provided to enhance exercise performance or recovery. To that end, in several embodiments, there is provided an endurance-enhancing formulation to enhance performance during a physical activity that occurs at an intensity about or below a ventilatory threshold of a subject, said formulation comprising one or more carbohydrates and one or more proteins, wherein the ratio of said carbohydrates to said proteins is 2.4:1 to 2.7:1, and wherein said formulation is suitable for oral consumption and adapted to enhance performance during a physical activity that occurs at an intensity about or below a ventilatory threshold. In several embodiments, said carbohydrates comprise one or more of dextrose, fructose and maltodextrin. In one embodiment, said carbohydrates comprise a combination of dextrose, fructose and maltodextrin. In several embodiments said protein comprises whey protein. Other protein sources are used in several embodiments, such as, for example, whey isolate, soy protein, rice protein, egg white protein, and the like.

In several embodiments, the formulation is in a form selected from the group consisting of a liquid form, a powdered form, a gel form, and a chewable form. Depending on the context of use of the formulation, certain forms may be preferable to others. For example, a powdered form is advantageous as it offers simple long-term storage, transport, and can be mixed just before consumption. In several embodiments, a liquid form is provided. In several embodiments, the liquid form is ready to drink. In some embodiments, a gel form is provided. Some embodiments of the gel form are reduced in volume as compared to a liquid form, but maintain the preferred carbohydrate to protein ratios disclosed herein

In one embodiment, the formulation is in liquid form and said carbohydrates are present in a total concentration of less than about 4.5 grams/100 mL and said protein is present in a total concentration of less than about 1.5 g/100 mL of said liquid. In several embodiments, said formulation provides about 17 calories in each 100 ml of the formulation. The low caloric content is advantageous in several embodiments as users may be seeking a performance advantage without the requirement of consuming a high-calorie formulation. Additionally, certain users may be specifically seeking a performance-enhancing formulation that can be used when reducing body mass. In several embodiments, dextrose is present in a concentration ranging from about 0.8-1.5 g/100 ml, maltodextrin is present in a concentration ranging from about 0.8-1.5 g/100 ml; and fructose is present in a concentration ranging from about 0.8-1.5 g/100 ml. While several embodiments use a mixed carbohydrate containing all three of glucose, maltodextrin, and fructose, in some embodiments, only two of these carbohydrates sources are used. Alternative carbohydrate sources (singular or mixed sources) may also be used in some embodiments, either in place of or in addition to one or more of glucose, maltodextrin, and fructose.

In several embodiments, the formulation further comprises a flavorant. Any flavorants suitable for use in an orally consumable formulation may be used, and include, as non-limiting examples, lemon-lime, fruit punch, chocolate, apple-cinnamon, berry, orange, tropical fruit, and the like. In some embodiments, the flavorant is chosen to enhance palatability during vigorous activity.

In several embodiments, said formulation is free from at least one of the following ingredients: caffeine, lactose, and gluten. In several embodiments, the formulation is prepared in order to be suitable for consumption by those with lactose intolerance and/or gluten allergies. Moreover, some users of the formulation may be sensitive to caffeine. In some embodiments, therefore, alternative stimulant compounds may be used, such as for example, ginseng, gotu kula, maitake, or taurine. In several embodiments, said formulation further comprises one or more of sodium, magnesium, potassium, and vitamin C. In some embodiments, the addition of ions assists in reducing cramping and/or muscle fatigue. For example, sodium and potassium are involved in the propagation of an action potential through muscle tissue. Misbalance of one, or both, of these ions can disrupt normal action potential transmission, which can cause tetanus of the muscles (recognized as cramping). Magnesium is involved in numerous enzymatic reactions including glycolysis, the Krebs cycle, creatine phosphate formation, nucleic acid synthesis, amino acid activation, cardiac and muscle contraction, cyclic AMP formation, and protein synthesis. Magnesium also stabilizes the molecule that functions as the body's energy currency, adenosine triphosphate (ATP) by binding to phosphate groups in ATP. Thus, consumption of magnesium is important, in several embodiments, to maintaining ATP levels that are sufficient for enhanced performance and recovery. Vitamin C is included in several embodiments, as high intensity activity, whether for short or longer periods of time, can negatively impact the body's immune system. Even the most-well trained athlete will suffer from reduced performance due to illness. Thus, in several embodiments, vitamin C is provided to function as an immune booster. In some embodiments, vitamin C also functions as an antioxidant, which helps to keep active muscles from generating oxidative compounds, which could lead to compromised performance and/or increased recovery times.

In several embodiments, consumption of said formulation before or during physical activity enhances endurance by at least about 10%, and in some cases, at least 15% or at least 20% as compared to consumption of a carbohydrate-only formulation. In several embodiments, consumption of said formulation before or during physical activity enhances endurance by at least about 20%, and in some embodiments, by at least 25% or at least 30%, or more, as compared to consumption of a carbohydrate and protein formulation with a carbohydrate to protein ratio of greater than 2.8:1. The balanced effect of the about 2.4:1 to about 2.7:1 carbohydrate:protein ratio advantageously provides greater enhancement of endurance with, in several embodiments, reduced overall caloric load, reduction in large swings in insulin concentrations, preservation of endogenous glucose stores, and/or improved recovery.

In several embodiments consumption of the formulation before or during physical activity regulates muscle glucose uptake and spares endogenous carbohydrate stores. In some embodiments, consumption of the formulation before or during physical activity increases the time to exhaustion during said physical activity. In several embodiments said increase in the time to exhaustion is achieved without an increased in perceived exertion during said physical activity. These effects work in concert to allow an individual to perform at a higher level, for a longer period of time, without a noticeable increase in the perception of exertion. Thus, individuals consuming the formulation are, in several embodiments, fresher for a longer period of time, and will often have an additional reserve of energy to overcome late-stage exercise fatigue.

Moreover, in several embodiments, consumption of the formulation before or during physical activity results in one or more of suppression of cortisol release, suppression of catecholamine release, suppression of cytokine release. Cortisol is a catabolic hormone, which can induce muscle tissue breakdown, thereby potentiating exercise-induced muscle damage and potentially adversely affecting muscle recovery. Catecholamine levels are involved in glycogenolysis and gluconeogenesis, and lower levels, in several embodiments, have glycogen sparing effects, thereby increasing the pool of reserve fuel available. Decreased levels of cytokines may also help reduce muscle inflammation, thereby improving performance and recovery. Moreover, in several embodiments, consumption of the formulation before or during physical activity results in an enhanced rate of protein synthesis, which assists in building lean muscle mass and reducing recovery time. As a result, enhanced rates of training adaptation are also achieved in several embodiments.

In several embodiments, there is provided a method of increasing a subject's time to exhaustion during physical activity that occurs at or below the ventilatory threshold of the subject comprising consuming a formulation comprising one or more carbohydrates and one or more proteins, wherein said formulation is suitable for oral consumption. In several embodiments, the ratio of said carbohydrates to said proteins is 2.4:1 to 2.7:1. In several embodiments, said carbohydrates comprise dextrose, fructose and maltodextrin. In several embodiments, said protein comprises whey protein. In several embodiments, consumption of said formulation before or during said exercise advantageously spares endogenous carbohydrate stores, allowing the exogenous carbohydrates to be preferentially burned by active muscles, and leaving a reserve of energy available to a subject, thereby enhancing endurance of said subject.

In some cases, enhanced physical performance depends as much on recovery as preparation. Therefore, in several embodiments, there is provided a recovery formulation to enhance recovery after physical activity comprising one or more carbohydrates, one or more proteins, and vitamin C having a concentration of up to about 1000 mg/100 ml, wherein the formulation is suitable for oral consumption and is adapted to increase muscle glucose uptake and reduce muscle protein breakdown, thereby improving recovery times. In some embodiments, vitamin C is optionally included in greater or lesser quantities, including formulations that do not include vitamin C. For example, in one embodiment, vitamin C is present in a concentration of about 90 mg/mL, while in another embodiment, vitamin C is present in a concentration of about 0.15 mg/mL.

In several embodiments, the ratio of said carbohydrates to said proteins is between about 2.4:1 to 2.7:1, including 2.5:1, 2.6:1, and ratios in between these values. In several embodiments, said carbohydrates comprise one or more of dextrose, fructose and maltodextrin. In one embodiment, said carbohydrates comprise a combination of dextrose, fructose and maltodextrin. In several embodiments said protein comprises whey protein. In several embodiments, said protein comprises whey protein. Other protein sources are used in several embodiments, such as, for example, whey isolate, soy protein, rice protein, egg white protein, and the like. In several embodiments, said dextrose, maltodextrin, and fructose in are present in a total a concentration of about 10-16 g/100 ml and wherein said protein is present in a total concentration of about 4-7 g/100 ml.

In several embodiments, the formulation further comprises one or more of sodium, magnesium, potassium, iron, and water. In one embodiment, the sodium has a concentration of about 70 mg/100 ml. In one embodiment, the magnesium has a concentration of about 80 mg/100 ml. In one embodiment, the potassium has a concentration of about 30 mg/100 ml. In one embodiment, iron is present in a concentration of about 2% of daily recommended intake. In one embodiment, a flavorant is also present in said formulation. In one embodiment, the water volume is about 100 mL (per serving). As discussed above in relation to active muscles, the inclusion of ions in several embodiments of the recovery formulation improves the recovery of ionic balance that may be lost during physical activity. Advantageously, the recovery formulation not only assists in the recovery of ionic balance, but also enhances rehydration. In several embodiments, consumption of the recovery formulation within about forty-five minutes post-activity increases muscle glucose uptake and reduces muscle protein breakdown. Ensuring that muscles have sufficient glucose (to convert to ATP) to regenerate muscle energy stores is important to the recovery process. Also, sufficient glucose and ATP levels are important the reducing muscle protein breakdown (and rebuilding/repairing muscle protein). In several embodiments, said formulation is in a form selected from the group consisting of a liquid form, a powdered form, a gel form, and a chewable form. In several embodiments, the formulation further comprises a flavorant. Any flavorants suitable for use in an orally consumable formulation may be used, and include, as non-limiting examples, lemon-lime, fruit punch, chocolate, apple-cinnamon, berry, orange, tropical fruit.

In several embodiments of the present invention, formulations comprising an optimal carbohydrate-to-protein ratio are provided. According to several embodiments of the present invention, formulations that comprise a unique blend of carbohydrates and protein are provided to enhance exercise performance or recovery. In one embodiment, an exercise performance formulation (or workout formulation) comprises a carbohydrate to protein ratio of about 2.4-2.6:1 (e.g., 2.5:1). In another embodiment, an exercise recovery formulation comprises a carbohydrate to protein ratio of about 2.5-2.7:1 (e.g., 2.6:1).

The exercise performance formulation (or workout formulation) according to several embodiments of the invention are particularly advantageous over formulations comprising only carbohydrates. In one embodiment, a 3% carbohydrate/1.2% protein formulation has certain advantages over a 6% carbohydrate-only formulation. In one embodiment, a 3% carbohydrate/1.2% protein formulation has certain advantages over a carbohydrate/protein formulation having a ratio of greater than 2.8 (e.g., 4). In one embodiment, the carbohydrate/protein formulation comprises glucose (dextrose), maltodextrin and fructose, and whey protein isolate. In one embodiment, the carbohydrate-only formulation comprises dextrose. In one embodiment, the carbohydrate/protein formulation contains half the carbohydrate content and 30% less calories in comparison to the carbohydrate-only formulation. In one embodiment, the carbohydrate/protein formulation is beneficial because it increases the time to exhaustion in comparison to the carbohydrate-only formulation, thereby enhancing performance. In further embodiments, the carbohydrate/protein formulation is particularly beneficial because improvement in performance occurs despite a lower carbohydrate and caloric content.

In one embodiment, the exercise performance and recovery formulations comprise an optimal blend of carbohydrates and protein for better performance and faster recovery. In several embodiments, the formulations comprise whey protein isolate, which is rich in essential amino acids and provides quick muscle recovery. Maltodextrin, a complex carbohydrate for long-lasting, sustained energy, is also included. In some embodiments, one or more of the following ingredients are also included: sodium to replenish losses due to perspiration, magnesium to aid in the protein synthesis that helps prevent muscle breakdown, potassium to help keep body fluids in balance, or combinations thereof. Additional vitamins and minerals may also be included, such as sodium, magnesium, potassium, and vitamin C.

In several embodiments, the exercise performance and recovery formulations are free of caffeine, gluten, and/or lactose. The formulations, according to several embodiments, are compliant with major sports governing bodies, and are free from substances that are prohibited by these bodies. In several embodiments, the exercise performance and recovery formulations are low in sugar and/or calories, while still providing one or more of the following benefits: reducing muscle damage; enhancing muscle tissue repair and development; replenishing muscle fuel stores rapidly; reducing muscle soreness; increasing rate of fuel absorption; improving fluid retention; and enhancing the hydration process.

In several embodiments of the invention, an endurance-enhancing formulation to enhance performance during a physical activity that occurs at an intensity about or below a ventilatory threshold of a subject is provided. In one embodiment, the formulation comprises one or more carbohydrates and one or more proteins. The ratio of the carbohydrates to the proteins is 2.4:1 to 2.7:1. The carbohydrates comprise dextrose, fructose and maltodextrin and the protein comprises whey protein, according to one embodiment. Other carbohydrates and proteins can be used in accordance with other embodiments of the invention. The formulation is suitable for oral consumption and adapted to enhance performance during a physical activity that occurs at an intensity about or below a ventilatory threshold.

In some embodiments, the formulation is in liquid form. In other embodiments, the formulation is in powered form. Gel forms and chewable forms are also provided. In some embodiments, the formulation comprises a flavorant. Other additives may also be included. For example, the powdered form may include one or more drying agents.

In one embodiment, the formulation is in liquid form and the carbohydrates are present in a total concentration of less than about 4.5 grams per 100 mL of the liquid form and the protein is present with a total concentration of less than about 1.5 g/100 ml of the liquid. In one embodiment, the formulation provides about 17 calories in each 100 ml of the formulation.

In some embodiments, consumption of the formulation before or during physical activity enhances endurance by at least about 10% as compared to consumption of a carbohydrate-only formulation. In some embodiments, consumption of the formulation before or during physical activity enhances endurance by at least about 20% as compared to consumption of a carbohydrate and protein formulation with a carbohydrate to protein ratio of greater than 2.8:1 (e.g., 4:1).

In several embodiments, a method of using, or instructing to use, the exercise performance and recovery formulations is provided. In one embodiment, a user is instructed to consume the exercise performance formulation before and during exercise and/or to consume the exercise recovery formulation after completing a workout (e.g., within about 10, 20, 30, 45, 60, 120 minutes after the workout).

In one embodiment, the exercise performance and recovery formulations are complementary and designed to be consumed as part of a program. For example, a user is instructed to consume an exercise performance formulation prior to and during exercise to improve endurance and reduce muscle tissue damage and to subsequently consume the exercise recovery formulation (within, e.g., about 30-45 minutes of completing a workout) to speed the storage of muscle and liver glycogen and promote muscle tissue repair. Thus, in one embodiment, a kit or package comprising both the exercise performance and exercise recovery formulations are provided, along with instructions for use. In other embodiments, a method of affecting physiological factors to improve exercise endurance and reduce muscle tissue damage is provided, wherein the method comprises providing a user with an exercise performance formulation and an exercise recovery formulation, and instructing the user when to consume the formulations (e.g., before/during exercise and within 45 minutes post-exercise). Physiological factors that may be affected include, but are not limited to: muscle glucose uptake, glycogen storage, muscle protein breakdown; cortisol, catecholamines and cytokine levels, insulin levels, muscle soreness, tissue repair, tissue development, fluid retention; hydration, and protein synthesis.

In several embodiments of the invention, a dual formulation system for enhancing one or more physiological effects during both exercise performance and post-exercise recovery is provided. In one embodiment, the dual formulation system comprises an exercise performance formulation and an exercise recovery formulation. The exercise performance formulation comprises a concentration of at least one type of carbohydrate in the range of about 2.4-4.5 g/100 ml and a concentration of at least one type of protein in the range of about 1.1-1.5 g/100 ml. The exercise recovery formulation comprises a concentration of at least one type of carbohydrate in the range of about 10-16 g/100 ml and a concentration of at least one type of protein in the range of about 4-7 g/100 ml. The ratio of carbohydrate to protein in both formulations is about 2.4 to 2.75 (e.g., about 2.5 or 2.6). The dual formulation system further comprises instructions to consume the exercise performance formulation before or during exercise and consuming the exercise recovery formulation within about forty-five minutes post-exercise.

Contrary to certain claims of carbohydrate and protein-containing beverages known in the art, Applicant has discovered and demonstrated that a carbohydrate to protein ratio of less than 2.8 is unexpectedly beneficial to enhancing the performance of the subject. Thus, in accordance with several embodiments of the formulations disclosed herein, it is not the mere addition of more carbohydrates and protein that benefits the consumer, but rather the scientifically balanced addition of carbohydrates relative to protein that enhances performance.

### BRIEF DESCRIPTION OF THE FIGURES

FIG. 1 depicts a cycling and sample collection protocol used to evaluate the effects of administration of different beverage formulations.

FIGS. 2A-2C depict the effects of different beverage formulations on time to exhaustion (TTE). FIG. 2A represents data from the combined group. FIG. 2B represents data grouped by exercise intensity at or below ventilatory threshold. FIG. 2C represents data grouped by exercise intensity above ventilatory threshold.

FIG. 3 depicts the effects of different beverage formulations on plasma insulin levels during exercise.

FIG. 4 depicts the effects of different beverage formulations on plasma glucose levels during exercise.

FIG. 5 depicts the effects of different beverage formulations on blood lactate levels during exercise.

FIG. 6 depicts the effects of different beverage formulations on plasma myoglobin levels during exercise.

FIG. 7 depicts a cycling and sample collection protocol used to evaluate the effects of administration of different beverage formulations when subjects exercised at or below their ventilatory threshold.

FIG. 8 depicts the effects of different beverage formulations on time to exhaustion when subjects exercised at or below their ventilatory threshold.

FIG. 9 depicts the effects of different beverage formulations on plasma insulin levels during exercise at or below the subject's ventilatory threshold.

FIG. 10 depicts the effects of different beverage formulations on plasma glucose levels during exercise at or below the subject's ventilatory threshold.

FIG. 11 depicts the effects of different beverage formulations on blood lactate levels during exercise at or below the subject's ventilatory threshold.

FIG. 12 depicts the effects of different beverage formulations on plasma myoglobin levels during exercise at or below the subject's ventilatory threshold.

FIG. 13 depicts the relative effects on time to exhaustion of either a carbohydrate only formulation, a high carbohydrate-high protein formulation and one embodiments of the performance formulation disclosed herein

FIG. 14 depicts the effects of two different carbohydrate and protein containing beverage formulations on time to exhaustion.

FIG. 15 depicts the effects of two different carbohydrate and protein containing beverage formulations on insulin levels.

FIG. 16 depicts the effects of two different carbohydrate and protein containing beverage formulations on glucose levels.

FIG. 17 depicts the effects of two different carbohydrate and protein containing beverage formulations on lactate levels.

FIG. 18 depicts the effects of different beverage formulations on sprint times during a simulated soccer match.

FIG. 19 depicts the effects of different beverage formulations on ratings of perceived exertion during sprint efforts.

FIG. 20 depicts the effects of different beverage formulations on run-time to exhaustion after a simulated soccer match.

### DETAILED DESCRIPTION

Optimal physical activity and performance requires a balance between proper nutrition and hydration before, during, and after activities. Whether in the context of casual exercise, activities directed to weight loss, exertion during performance of job duties, or athletic competition, dehydration and depletion of endogenous energy stores may compromise performance and recovery. Absent proper hydration and replacement or supplementation of energy stores, either during or after exertion, an individual's performance (athletic or occupational), recovery and health may be compromised.

Concurrent with increasing information about the body's nutritional demands and biochemical pathways, numerous approaches and theories have been developed with respect to diets, supplements, and beverages that promote optimized for performance and recovery. While many attempts to improve performance and/or endurance have used high carbohydrate liquid formulations as an energy source, many carbohydrate-only formulations stimulate only limited glucose absorption, thus reducing their effectiveness at maintaining performance during exercise or replenishing glycogen stores post-exercise. Moreover, the high carbohydrate content often results in a short peak of increased energy followed by a subsequent “crash”, where energy levels return to, or even fall below, pre-ingestion levels. Thus, there exists a need for a formulation that provides optimized hydration and nutrients for both performance and recovery.

In addressing this need, several embodiments of the formulations disclosed herein comprise a mixture of carbohydrates and protein. While it has long been recognized that endurance exercise performance is significantly improved when carbohydrate is ingested during exercise, as compared to water only, the unbalanced addition of other nutrients to a sports beverage may adversely impact performance. For example, supplements having high protein levels may adversely affect the gastric system, thereby reducing the absorption of the water and carbohydrate portions of the beverage. The result is that a beverage designed to enhance hydration and performance in reality hinders both. To reduce or avoid this effect, several embodiments of the formulations disclosed herein have an optimal protein to carbohydrate ratio, which effectively stimulates carbohydrate uptake without adversely impacting gastric emptying rates or palatability, thereby increasing water absorption and energy for active muscles as well as aiding in recovery of muscle tissue and hydration post-activity.

Several embodiments of the invention are particularly advantageous because they provide optimized hydration and/or recovery with a lower caloric content, thereby assisting in maintaining or reducing body weight, in addition to improving fitness and endurance.

### Exercise Performance (Workout) Formulation

In several embodiments, an exercise performance (or workout) formulation is provided. In some embodiments, a formulation comprising a ratio of carbohydrate to protein of less than 2.8:1 is provided. In some embodiments, the formulation is prepared for use as a supplement. In some embodiments, the formulation is provided as energy, or sports drink.

In several embodiments, the exercise performance formulation optimizes aerobic exercise performance and reduces muscle damage during exercise. The formulation, in some embodiments, also enhances rehydration during exercise and post exercise. Contrary to teachings in the related art, several embodiments of the formulation disclosed herein do not adversely impact gastric emptying, and do not slow rehydration and glucose absorption during exercise. Indeed, several embodiments facilitate rehydration associated with exercise and facilitate glucose absorption.

During exercise, the body experiences an acute increase in metabolism, which increases the body's consumption of water. Adaptation to exercise (e.g., gain of fitness) induces a longer-term increase in the body's metabolism, which also increases the body's consumption (and need) for water. Absent proper replenishment of this water, dehydration may result, which, in turn, may result in muscle cramps, reduced performance (both acutely and long-term), and in severe cases illness and/or organ failure. In some instances, the increased metabolism leads to the development of a catabolic state in which the body recruits its endogenous fuel sources for energy. This can lead to the depletion of muscle and liver glycogen and the breakdown of muscle protein. During this catabolic state there is also suppression of the immune system. Several embodiments of the exercise performance formulation provide hydration upon consumption, thereby preventing or reducing dehydration. Several embodiments of the exercise performance formulation provide an exogenous source of carbohydrate, thus reducing the catabolism of endogenous energy stores. In some embodiments, the exercise performance formulation also reduces the reliance on endogenous fuel sources. As such, several embodiments of the exercise performance formulation significantly extend time to exhaustion during aerobic exercise. In some embodiments, the exercise performance formulation significantly extends endurance and/or performance during other activities (e.g., manual labor, military performance).

Intensity of exercise or other physical activity is a factor affecting the duration of time than an individual can actively perform the activity. Intensity may also be a factor in the efficacy of various beverage formulations. A variety of approaches to athletic training regimens exists, but many use certain markers of intensity to formulate and execute specific workouts. Many markers exist, such as VO₂max, lactate threshold, ventilatory threshold, and percent of maximum heart rate. In several embodiments, the performance formulation enhances endurance when activity takes place at or around an individual's VO₂max, at or around an individual's lactate threshold, at or around an individual's ventilatory threshold, or from about 65 to about 90% of an individual's maximum heart rate. These embodiments are particularly advantageous as ability to exercise for long periods at an intensity near one of these markers of intensity becomes a critical component of performance in long events such as marathons, longer cycling races and long-distance triathlons. As endurance athletes self-select intensities approximating these intensity markers during training and competitions, several embodiments of the performance formulation particularly benefit these individuals.

In several embodiments, the protein content of the performance formulation reduces damage to muscle tissue. In some embodiments, the performance formulation enhances the recovery of muscle tissue that has sustained damage. In several embodiments, one or more markers or muscle damage is reduced after ingestion of one of several embodiments of the performance formulation. Such markers include, but are not limited to creatine phosphokinase (CPK), lactate dehydrogenase, and myoglobin. In some embodiments, the reduction in muscle damage is detected in a short time frame after exercise, whereas in some embodiments a longer-term response (e.g., long term muscle recovery) is achieved. In some embodiments, reductions in muscle damage are achieved on both a short-term and a long-term basis.

In several embodiments, the protein content is optimized relative to the carbohydrate content to provide enhanced performance and/or recovery without adversely impacting gastric emptying or causing gastric distress to the consumer.

In some embodiments, the performance formulation inhibits the signaling cascade that leads to perception of fatigue. Fatigue is thought to be related to levels of brain 5-hydroxytryptamine (5-HT, serotonin), which regulates arousal, mood, motivation and fatigue in humans. Free tryptophan is a precursor for serotonin production. Free tryptophan shares the same blood transporter as plasma free fatty acids, and numerous amino acids. An increase in blood free fatty acid production during exercise, in addition to an increased amino acid uptake into the muscle results in increased free tryptophan in the blood. This increases the free tryptophan may move across the blood brain barrier, potentially increasing 5-HT production and feelings of fatigue. In several embodiments, the performance formulation prevents a rise in serotonin production through decreased free tryptophan levels during exercise, allowing individuals to exercise longer without experiencing the sensation of exhaustion. Regulation of neurotransmitters is provided in several embodiments of the invention. In one embodiment, mental acuity and/or mood are enhanced.

Several embodiments are advantageous for additional reasons. For example, in several embodiments, the performance formulation provides improved performance and endurance despite a low caloric content. In some embodiments, therefore, the formulation assists in maintaining or reducing body weight. In some embodiments, the drink helps support the immune system.

In several embodiments, the exercise performance formulation comprises a unique blend of carbohydrates in conjunction with a whey protein isolate. In some embodiments, this combination stimulates cellular signaling pathways that regulate muscle glucose uptake and reduce muscle protein breakdown. In some embodiments, the blend of carbohydrates increases the rate of glucose uptake and, in combination with the protein, increases the blood insulin response above that of carbohydrate alone. In other embodiments, glucose absorption is upregulated despite more constant levels of insulin release. This will result in muscle glycogen sparing and inhibition of muscle protein breakdown. In some embodiments, endogenous carbohydrates (glycogen) is spared in the absence of significant changes in plasma glucose and/or insulin. In several embodiments, a high insulin response and/or an increase in blood glucose post exercise will induce suppression of blood cortisol, catecholamines and cytokine levels, and reduce stress on the immune system. Moreover, the addition of protein to the drink will help with fluid retention and rehydration post exercise. Several embodiments of the performance formulation, which comprise a ratio of carbohydrate to protein in a ratio of less than 2:8:1 (e.g., a ratio of 2.5:1), offer specific advantages because of the additive or synergistic effects of the carbohydrates and proteins in the given ratio.

Insulin and muscle contraction are considered the major stimulators of glucose transport and both carbohydrate and protein are believed to stimulate insulin release, under certain conditions. In some embodiments, the performance formulation stimulates insulin release and subsequent glucose absorption. In several embodiments, the combination of carbohydrate and protein in the performance formulation yield a greater increase in insulin response as compared to ingestion of either carbohydrate or protein alone. In some embodiments, the performance formulation stimulates plasma glucose absorption independently of insulin. In several embodiments, the combination of carbohydrate and protein in the performance formulation increases glucose clearance from the blood at a greater rate than carbohydrate beverages alone, resulting in lower blood glucose levels and increased exogenous carbohydrate availability to the working muscle.

In several embodiments, the exercise performance formulation can be taken before, during, and/or after exercise. The formulation, according to several embodiments, increases the rate of glucose uptake, providing an exogenous carbohydrate fuel source, and provides amino acids, which help to reduce muscle damage during exercise. In some embodiments, the carbohydrate and protein work additively or synergistically to promote better fuel utilization. The formulation, according to preferred embodiments, also supports the immune system. The electrolytes provide replacement electrolytes lost during exercise and, when combined with the protein, will increase fluid retention more effectively than a carbohydrate/electrolyte formulation that lacks protein.

As discussed earlier, the ratio of carbohydrate to protein in preferred embodiments of the present invention is about or less than 2.8:1. In some embodiments, the ratio is in the range of 1.85 to 2.75. In other embodiments, the ratio is in the range of 1.0 to 1.85. In yet other embodiments, the ratio is 2.4, 2.5, 2.6, or 2.7.

Absorption and utilization of exogenous carbohydrates may be limited by many factors, including, but not limited to, the amount of carbohydrate ingested, the intensity of any activity ongoing during ingestion of the carbohydrate, other nutrients ingested before, along with, or after ingestion of the carbohydrate, and the composition of the carbohydrate. In several embodiments of the performance formulation, a single type of carbohydrate is used. However, in several other embodiments of the performance formulation, multiple sources of carbohydrate are used. In some embodiments, two, three, four, five, or more different types of carbohydrates are used in the performance formulation. In some embodiments, the multiple sources of carbohydrates are simple carbohydrates, while in other embodiments, complex carbohydrates are used. In still additional embodiments, mixtures of simple and complex carbohydrates are used.

In some embodiments, the utilization of multiple types of carbohydrates increases the overall rate of carbohydrate absorption and/or utilization. In some embodiments, the increase is due to different mechanistic processing of the various types of carbohydrates. In some embodiments, the use of multiple types of carbohydrates optimizes the various intestinal carbohydrate transporters, leading to increased carbohydrate absorption. In turn, the increased absorption may lead to increased exogenous carbohydrate oxidation and decreased endogenous carbohydrate oxidation. As a result, a consumer of the performance formulation may be more efficiently using the carbohydrate component of the performance formulation more efficiently, while endogenous carbohydrate stores are maintained. Maintenance of the endogenous stores therefore provides an individual with a “reserve” supply of energy that can be recruited when exogenous carbohydrates are depleted or absent. These “reserves” are thus available for use during an extended workout session, thereby increasing the performance and/or endurance of an individual. In several embodiments, the increase in usage of exogenous carbohydrates thus allows the increased preservation of endogenous carbohydrate stores. As such, if there should come a point during a period of exertion when the exogenous carbohydrate source is insufficient, there is an increased level of “reserve fuel” available for recruitment at that time. Moreover, the readily useable nature of the reserve endogenous carbohydrate stores makes them preferable, in several embodiments, as compared to the recruitment of gluconeogenesis pathways, which are less efficient and time-delayed.

In several embodiments, the performance formulation enhances performance and/or endurance by maintaining or increasing the muscle capacity for aerobic energy production during exertion. Krebs cycle intermediates are thought to increase at the onset of exercise and progressively decline as exercise continues. Thus in some embodiments, the increase in performance is due to the enhanced maintenance of Kreb's cycle intermediates, including but not limited to alpha-ketoglutarate, citrate and malate. In some embodiments, the optimized carbohydrate to protein ratio enhances mitochondrial efficiency and/or activity. In several embodiments of the performance formulation, a mixture of carbohydrates beneficially affects the levels of muscle glycogen use and Krebs cycle intermediates compared to a supplement containing a single carbohydrate with added protein, or as compared to carbohydrate alone.

In several embodiment, the exercise performance formulation disclosed herein comprises the following ingredients, in the following approximate concentrations:

| | |
|---|---|
| Dextrose | 0.8-1.5 g/100 ml |
| Maltodextrin | 0.8-1.5 g/100 ml |
| Fructose | 0.8-1.5 g/100 ml |
| Whey Protein | 1.1-1.5 g/100 ml |
| Sodium | 70 mg/100 ml |
| Magnesium | 30 mg/100 ml |
| Potassium | 30 mg/100 ml |
| Vitamin C | 15 mg/100 ml |
| Water | 100 ml |

In other embodiments, the following concentrations are used:

| | |
|---|---|
| Carbohydrates | 1-8.25 g/100 ml |
| Protein | 1-3 g/100 ml |
| Sodium | 0-100 mg/100 ml |
| Magnesium | 0-100 mg/100 ml |
| Potassium | 0-100 mg/100 ml |
| Vitamin C | 0-1000 mg/100 ml |
| Water | 100 ml |

In some embodiments, the exercise performance formulation comprises dextrose, maltodextrin, and fructose as the preferred carbohydrate source. In one embodiment, maltodextrin is advantageous because it reduces the osmolality of the drink, thereby permitting faster gastric emptying. The dextrose and maltodextrin breakdown in the intestines and are transported into the circulatory system as glucose by glucose transporters (particularly the sodium-dependent glucose cotransporter (SGLT1). Fructose is transported by its own transporter (GLUT 5), thus increasing the rate of carbohydrate uptake and producing a greater reliance on exogenous fuel during exercise.

In some embodiments, the exercise performance formulation comprises the following ingredients in an approximately 80 calorie serving: fat (0 g); sodium (330 mg); potassium (140 mg); carbohydrate (15 g); protein (6 g); vitamin C (110% of the daily recommended intake); and magnesium (35% of the daily recommended intake). In one embodiment, the formulation is provided as a 16 ounce serving size having about 80 calories, and in several embodiments, is suitable for rehydration.

In some embodiments, the exercise performance formulation comprises whey protein, dextrose, maltodextrin, crystalline fructose, citric acid, sodium chloride, magnesium sulfate, monopotassium phosphate, natural and artificial flavors, silicon dioxide, ascorbic acid, sucralose, yellow 5 lake, and blue 1 lake.

In several embodiments, the invention comprises an exercise performance (or workout) formulation that consists, consists essentially of or comprises a carbohydrate to protein ratio of 2.4-2.7 (e.g., 2.5, 2.67) and has less than 1%, 5% or 10% of an individual's recommended or average daily caloric value. In one embodiment, the invention comprises an exercise performance formulation that consists, consists essentially of or comprises a carbohydrate to protein ratio of 2.4-2.7 (e.g., 2.5, 2.67) and has less than 100 calories. In one embodiment, the formulation has a ratio of 2.5, with 15 grams of carbohydrates and 6 grams of protein, and has about 80-85 calories. Surprisingly, with the proper ratio of carbohydrates and protein, as disclosed in several embodiments herein, the calorie value does not need to be high to achieve results.

Although several embodiments of the invention comprise a formulation for endurance exercise performance (e.g., marathons, distance road cycling, and long-distance triathlons), it shall be appreciated that the performance formulations are not limited to this context. High levels of endurance are required in numerous situations inside and outside the sporting world. Sports such as soccer, tennis, volleyball, and baseball have the capacity to last several hours, with success reliant on lasting endurance during the later stages. Moreover, professionals such as firefighters and military personnel are routinely required to maintain high levels of physical and mental performance for prolonged periods, and prolonging time to exhaustion can be critical for the success of their mission or even survival.

### Exercise Recovery Drink

In several embodiments, an exercise recovery drink is provided. In one embodiment, an energy formulation comprising a ratio of carbohydrate to protein of less than 2.8:1 is provided. In some embodiments, the formulation is prepared for use as a supplement. In one preferred embodiment, the formulation is provided as an energy or sports drink.

In several embodiments, the exercise recovery formulation provides one or more of the following advantages: optimizes recovery from exercise, stimulation of muscle glycogen repletion, tissue repair and protein synthesis, and enhancement of the rate of training adaptation. In several embodiments, the exercise recovery formulation provides all three of the advantages identified above. As discussed earlier, exercise results in the development of a catabolic state in which the body recruits its endogenous fuel sources for energy resulting in the depletion of muscle and liver glycogen and the breakdown of muscle protein. During this catabolic state, suppression of the immune system also occurs. Consumption of the exercise recovery drink post-exercise will, in several embodiments, rapidly provide carbohydrates for the replenishment of muscle and liver glycogen and amino acids for the repair of muscle. Moreover, according to some embodiments, the formulation will result in a cellular environment that: (i) enhances the rate of protein synthesis, (ii) facilitates faster training adaptation, and (iii) supports the immune system.

In several embodiments of the exercise recovery formulation disclosed herein comprises a unique blend of carbohydrates along with a whey protein isolate. In some embodiments, this combination stimulates cellular signaling pathways that regulate muscle glycogen storage and protein synthesis. In some embodiments, the blend of carbohydrates will increase the rate of glucose uptake and, in combination with the protein, will increase the blood insulin response above that of carbohydrates alone. In combination with an enhanced activation of the insulin signaling pathway, rapid uptake of carbohydrate and elevation in plasma insulin, as well as muscle and liver glycogen storage, are rapidly increased. Likewise, the elevation in insulin and blood amino acids from the ingestion of the protein will act additively or synergistically on the mTOR-signaling pathway. In one embodiment, this will increase the rate of mRNA translation and protein synthesis, promoting muscle tissue repair and stimulate training adaptation, which is the over expression of proteins involved in exercise performance. In one embodiment, the high insulin response coupled with the increase in blood glucose post exercise will also suppress blood cortisol, catecholamines and cytokine levels and reduce stress on the immune system. As discussed above, in several embodiments, these physiological effects occur and/or are detectable, even in the absence of a significant rise in insulin levels.

In several embodiments of the exercise recovery formulation, which comprise a ratio of carbohydrate to protein in a ratio of less than 2:8:1, offer several advantages because of the combined effects of the carbohydrates and proteins in the given ratio. In some embodiments, the carbohydrates and proteins produce additive results. In other embodiments, the carbohydrates and proteins produce synergistic results.

As discussed earlier, the ratio of carbohydrate to protein in embodiments of the exercise recovery formulation is less than 2.8:1. In some embodiments, the ratio is in the range of 1.85 to 2.75. In some embodiments, the ratio is in the range of 1.0 to 1.85. In yet other embodiments, the ratio of the recovery formulation is 2.4, 2.5, 2.6, or 2.7.

As discussed above, absorption and utilization of exogenous carbohydrates may be limited by many factors, including, but not limited to, the amount of carbohydrate ingested, other nutrients ingested before, along with, or after ingestion of the carbohydrate, and the composition of the carbohydrate. As discussed above, in some embodiments a single type of carbohydrate is used in the recovery formulation. However, in several embodiments, multiple sources of carbohydrate are used in the recovery formulation. In some embodiments, two, three, four, five, or more different types of carbohydrates are used in the recovery formulation. In some embodiments, the multiple sources of carbohydrates are simple carbohydrates, while in other embodiments, complex carbohydrates are used. In still additional embodiments, mixtures of simple and complex carbohydrates are used. In some embodiments, the utilization of multiple types of carbohydrates increases the rate of absorption and/or utilization. In some embodiments, the increase is due to different mechanistic processing of the various types of carbohydrates.

In several embodiments, the exercise recovery formulation comprises the following ingredients, in the following approximate concentrations:

| | |
|---|---|
| Dextrose | 4-6 g/100 ml |
| Maltodextrin | 4-6 g/100 ml |
| Fructose | 2-4 g/100 ml |
| Whey Protein | 4-7 g/100 ml |
| Sodium | 70 mg/100 ml |
| Magnesium | 80 mg/100 ml |
| Potassium | 30 mg/100 ml |
| Vitamin C | 90 mg/100 ml |
| Water | 100 ml |

In other embodiments, the following concentrations are used:

| | |
|---|---|
| Carbohydrates | 5-30 g/100 ml |
| Protein | 2-15 g/100 ml |
| Sodium | 0-100 mg/100 ml |
| Magnesium | 0-100 mg/100 ml |
| Potassium | 0-100 mg/100 ml |
| Vitamin C | 0-1000 mg/100 ml |
| Water | 100 ml |

In several embodiments, the exercise recovery formulation comprises the following ingredients in an approximately 260 calorie serving: fat (0 g); cholesterol (5 mg) sodium (250 mg); potassium (125 mg); carbohydrate (47 g); protein (18 g); vitamin C (520% of the daily recommended intake); and iron (2% of the daily recommended intake).

In some embodiments, the exercise recovery formulation comprises whey protein, dextrose, maltodextrin, crystalline fructose, citric acid, magnesium sulfate, natural and artificial flavors, silicon dioxide, ascorbic acid, monopotassium phosphate, sodium chloride, sucralose, yellow 5 lake, and blue 1 lake.

In one embodiment, the exercise recovery drink can be taken before, during, and/or after exercise. In preferred embodiments, the formulation increases the rate of glucose uptake, providing carbohydrate for glycogen replenishment, and provides amino acids for protein synthesis. According to some embodiments, the carbohydrate and protein work additively or synergistically to promote glycogen storage, protein synthesis and muscle tissue repair. The immune system is supported in several embodiments. The electrolytes provided in several formulations replace electrolytes lost during exercise, but also increase glucose uptake from the intestines to the circulation. Recovery formulations according to several embodiments herein are beneficial for athletes, military personnel, and any subject that can benefit from the effect described herein. For example, patients recovering from an illness or injury are benefited by the formulations disclosed herein in several embodiments.

### Exercise Performance and Recovery Formulations

Both the exercise performance and recovery formulations described herein comprise a ratio of about 1-2.75 carbohydrate for every 1 protein. Preferably, the ratio is 1.85 to 2.75. In other embodiments, the ratio of carbohydrate to protein is 1.0, 1.2, 1.4, 1.6, 1.8, 2, 2.2, 2.4, or 2.6. In one embodiment, the performance formulation has a ratio of 2.4-2.6 and the recovery formulation has a ratio of 2.5-2.7.

Carbohydrates used in several embodiments of the exercise performance and recovery formulations include dextrose, maltodextrin, and fructose, but may include other carbohydrates. For example, in some embodiments, one or more of the following carbohydrates can be used instead of or in addition to dextrose, maltodextrin, and/or fructose: glucose, maltose, maltotriose, lactose, galactose, sucrose, high fructose corn syrup, beet sugar, cane sugar, arabinose, ribose, sorbose, tagatose and sorbitol.

In several embodiments, a combination of different carbohydrates (rather than a single type) is used to increase the rate of muscle fuel (glycogen) reloading and recovery. In some embodiments, the combination of carbohydrates used for both the performance and recovery formulations is dextrose, maltodextrin, and fructose. Using a blend of carbohydrates provides, in some embodiments, a beneficial diversity in absorption rates and glycemic index, which in turn can enhance the rate of glycogen reloading and recovery.

Sweetening agents may also be used in several embodiments. The sweetening agents may be a source of carbohydrate (such as glucose or fructose), or may be an artificial sweetener with negligible caloric value, including but not limited to, sucralose, stevia, saccharin, agave, sugar alcohols, aspartame, or combinations thereof. Other flavoring agents may also be used. Caffeine or other stimulants may be included in alternative embodiments. Epigallocatechin gallate (EGCG), may be used in some embodiments. In several embodiments, the formulations do not contain any caffeine, EGCG, or like stimulant.

In one embodiment, the exercise performance and recovery formulations comprise whey protein (isolate, hydrolyzate, or concentrate) as the preferred protein source. The whey protein contains all essential amino acids in high concentration and readily dissolves in solution when mixed. Proteins other than whey may also be used. For example, one or more of the following proteins can be used instead of or in addition to whey protein: soy protein, egg protein, rice protein, casein, and protein blends. Individual amino acids may also be used.

In some embodiments, the exercise performance and recovery formulations comprise sodium, magnesium, and potassium to replace electrolytes lost during exercise. Electrolytes that may be used instead of or in addition to sodium, magnesium, and/or potassium include, but are not limited to, calcium. Other electrolytes may also be used.

In some embodiments, the exercise performance and recovery formulations comprise Vitamin C as an antioxidant. Other antioxidants may also be used, including but not limited to vitamin A, beta carotene, and alpha lipoic acid. In some embodiments, other vitamins and minerals are included. For example, vitamin B may be used in some embodiments. Omega fatty acids may be included in some embodiments. Calcium, magnesium and/or other minerals may be added in several embodiments.

In some embodiments, the exercise performance and recovery formulations are provided in a powdered or otherwise dehydrated form. In one embodiment, instructions for use that instruct a user to add water (or other liquid) to the dehydrated form are provided. In other embodiments, the formulations are provided in a sustained or slow release form. In some embodiments, the formulations are provided in solid or gelatinous forms. In yet other embodiments, the formulations are provided in a soft chew, hard candy, or gum format. Ready-to drink formulations are provided in several embodiments.

In some embodiments, the exercise performance and recovery formulations are free from lactose, and are therefore suitable for individuals that are lactose intolerant. In several embodiments, the formulations are gluten free. In other embodiments, the formulations are caffeine free. In yet other embodiments, the formulations are free from any compound prohibited by governing sports authorities.

In some embodiments, the exercise performance and recovery formulations comprise or consist essentially of certified organic ingredients or other natural ingredients.

Unlike the drinks disclosed in the related art, several embodiments disclosed herein provide an exercise performance and/or recovery drink that is low in calories, while still enhancing performance and recovery. In drinks that use a 4:1 ratio of carbohydrate to protein, 20 grams of carbohydrates would be needed in any drink that contained just 5 grams of protein. This high quantity of carbohydrates is unpalatable to many recreational and professional athletes. By contrast, in several embodiments of the formulations disclosed herein, an exercise drink contains 5 grams of protein, and only 5 grams to 13.75 grams of carbohydrates. In some embodiments, the reduction in carbohydrates allows a sports drink to contain fewer calories. In some embodiments, the caloric value can be the same as other drinks, but more of those calories can come from protein instead of carbohydrates. Lower caloric values per serving size, according to some embodiments of the formulations, are particularly advantageous in terms of the reduced glycemic load of the formulations (e.g., drinks) as compared to other sports or energy drinks or products.

As described above, prior to Applicant's invention, several references taught that “carbo-loading” prior to exercise was the most efficient way to stock muscles with fuel. However, Applicant has determined that insulin in the blood was more effective at carrying energy into the muscles if those muscles had recently been active. It is believed that exercise makes muscles more responsive to insulin, and this insulin, in turn, increases glycogen muscle uptake. Exercise prompts muscles to absorb more fuel from the bloodstream. This improved insulin response, however, lasts only for a brief time (e.g., about 30-45 minutes) after a workout. After that, it is believed that muscles become resistant to insulin and much less able to absorb glucose. Thus, consuming carbohydrates within about 30 or 45 minutes after a strenuous workout is beneficial to restoring the glycogen burned. It is believed that waiting a few hours post-workout diminishes the body's ability to restore glycogen by nearly 50%. However, the consumption of carbohydrates alone is not optimal. Protein is also important, and more particularly, the ratio between the carbohydrate and the protein has a significant impact on both performance and recovery. Consuming protein with carbohydrates can accelerate muscle glycogen repletion by stimulating endogenous insulin release. Moreover, specific ratios of protein and carbohydrates, such as those described herein, are more beneficial than others.

In one embodiment, a method of using, or instructing to use, the exercise performance and recovery formulations is provided. For example, in one embodiment, a user is instructed to consume the exercise performance formulation before and during exercise. In another embodiment, a user is instructed to consume the exercise recovery formulation after completing a workout (e.g., within about 10, 20, 30, 45, 60, or 120 minutes after the workout). In some embodiments, the user may be instructed to consume the recovery formulation later than about two hours post-workout. In some preferred embodiments, a user is instructed to consume the recovery formulation within about 30-45 minutes post-exercise.

In several embodiments, the exercise performance and recovery formulations are complementary and designed to be consumed: (i) before and during exercise to improve endurance and reduce muscle tissue damage (with respect to the exercise performance formulation); and (ii) within about 30-45 minutes of completing a workout to speed the storage of muscle and liver glycogen and promote muscle tissue repair (with respect to the exercise performance formulation). Thus, in some embodiments, both the exercise performance and exercise recovery formulations are provided together, along with instructions for use.

It is believed that during exercise, the muscles become sensitive to certain hormones and nutrients, and many highly desirable training adaptations can be initiated if the correct nutrients, in the correct ratios, are present. The increased sensitivity of the muscles typically lasts for a limited length of time; therefore, timing becomes important. Thus, instructing a user to consume the exercise performance formulation before/during a work-out and the exercise recovery formulation post-workout is advantageous in several embodiments because it optimizes the stimulation of certain muscle adaptations.

### EXAMPLES

Examples provided below are intended to be non-limiting embodiments of the invention.

### Example 1

### Effect of Moderate Carbohydrate—Protein Formulation on Exercise Performance

The following materials, methods, and protocols may be used to perform the examples disclosed herein as well as practice several embodiments of the invention disclosed herein.

### Diet And Exercise

Subjects were instructed to maintain training and dietary logs for the 2 and 3 days, (respectively) before the cycling familiarization trial and to keep training and diet consistent with that record for the days prior to the cycling experimental trials. Subjects provided a copy of their training and dietary logs on the day of the trials. An investigator reviewed and verified the entries in the logs with the subjects at each session in order to verify that compliance with the previous logs was attained. The data from the logs were entered into Nutribase Clinical Nutrition Manager 7.17 (CyberSoft, Inc., Phoenix, Ariz.) for nutritional analysis. Diets were not standardized, as each subject served as his or her own control. All subjects complied with the diet and exercise requirements.

### Blood Sampling

For experimental trials, a catheter fitted with a three-way stopcock and extended with a catheter extension was inserted into an antecubital vein of each subject and taped in place.

Prior to receiving the first beverage dose and beginning the trial, a 5 ml sample of blood was collected and the catheter was flushed with saline. For cyclists, 5 ml samples were drawn at 3 additional time points: at 118 min of exercise, at 177 min of exercise, and immediately after exercise ceased due to exhaustion. Saline flushes occurred every 10-15 min during the entire protocol to keep the catheter patent.

### Ventilation, VO₂, RER, Heart Rate and RPE

Ventilation, VO₂, CO₂ production, and respiratory exchange ratio (RER) were recorded using the same ParvoMedics TrueOne 2400 system that was used during the VO₂max test and familiarization trials. The system was calibrated immediately before each trial using medical-grade gases of known concentrations and a 3.0 L calibration syringe. Collections were made at 4 time during cycling trials points: 10-15 min (low intensity), 46-51 min (high intensity), 130-136 min (low and high intensity, 3 min each) and for the first 5 min of the exhaustion portion. With the exception of the 130-136 min collection, respiratory gases were collected for 5 min using 15 sec sampling, and only the last 1.5 min of each collection were used to determine steady-state VO₂ and RER. For the 130-136 min collection (3 min of low intensity and 3 min of high intensity), the last minute of each interval was used. Heart rate (HR) was recorded at the beginning of exercise and at every 10-15 min of exercise. Subjective ratings of perceived exertion (RPE) on a Borg scale (ranging from 6 to 20) were obtained during exercise at the same time points as HR.

### Substrate Utilization

Determination of substrate (carbohydrate and fat) oxidation rates were made from VO₂, VCO₂, and RER values using the collection times as described above during the experimental trials by established methods.

### Biochemical Analyses of Plasma Metabolites

Each 5 ml blood sample was anticoagulated with 0.3 ml of EDTA (24 mg/ml, pH 7.4), and 0.5 ml of the anticoagulated blood was transferred to another tube containing 1 ml 10% perchloric acid (PCA). All tubes were centrifuged at 4° C. for 10 min at 3,000 rpm with a HS-4 rotor in a Sorvall RC6 centrifuge (Kendro Laboratory Products, Newtown, Conn.). After centrifugation, plasma and PCA extracts were separated into aliquots for each assay and immediately frozen and stored at −80° C. for later analysis. The plasma samples were analyzed for insulin by radioimmunoassay and had a coefficient of variation (CV) of 6.0%. Myoglobin concentrations were determined by solid phase ELISA (BioCheck, Inc., Foster City, Calif.), with a CV of 5.4%. Blood lactate was determined from the PCA extract by enzymatic-spectrophotometric analysis method based on the oxidation of lactate to pyruvate by nicotinamide adenine dicnucleotide (NAD⁺), and had a CV of 1.5%. Plasma glucose was measured using a spectrophotometric Trender reaction (no. 315, Sigma Chemical, St. Louis, Mo.) and had a CV of 3.7%. All assays were run in duplicate.

### Statistical Analyses

The data were analyzed using a general linear model for repeated measures. Time to fatigue was analyzed using a 1-way analysis of variance (ANOVA). All the other variables that included multiple measures per trial were analyzed using a 2-way ANOVA (treatment 3 time). Post hoc analysis was performed when significance was found using Fisher's least square difference. The level of significance for all analyses was set at p<0.05. All data are expressed as mean 6 SEM. SPSS version 16.0 statistical software (SPSS Inc., Chicago, Ill., USA) was used for all statistical analyses.

### Preliminary Testing

Prior to beginning the experimental time to exhaustion (TTE) cycling trials, subjects reported to the laboratory for determination of their VO₂max. The VO₂max tests and all experimental trials were performed on the same cycle ergometer (Velotron Dynafit Pro, Racermate, Seattle, Wash.). The protocol for establishing VO₂max consisted of a 4 min warm up, then 2 min stages beginning at 200 watts (W) for males or 130 W for females. The work load was increased by 50 W (males) or 35 W (females) every 2 min until 350 W and 200 W, respectively. After this point, the workload increased 25 W (males) or 10 W (females) every minute until the subject could not continue to pedal despite constant verbal encouragement. The criteria used to establish VO₂max was a plateau in VO₂ with increasing exercise intensity and a respiratory exchange ratio (RER)>1.10. During the test, subjects breathed through a Hans Rudolph valve, with expired gases directed to a mixing chamber for analysis of oxygen (O₂) and carbon dioxide (CO₂) (ParvoMedics TrueOne2400, ParvoMedics, Sandy, Utah). Outputs from this system were directed to a laboratory computer for calculation of ventilation, O₂ consumption (VO₂), CO₂ production (VCO₂), and RER every 15 seconds.

Maximum power output in Watts was calculated from the VO₂max test data using an established formula:

Wₘₐₓ=(VO₂max mL−300 mL O₂)/12.5 W/mL O₂

The workloads were then set as percentages of the Wattsₘₐₓ as follows:

W=[(VO₂max mL×% VO₂max desired)−300 mL O₂]/12.5 W/mL O₂

Each experimental cycling trial was separated by a minimum of 7 days, not to exceed 14 days.

### Experimental Cycling Protocol

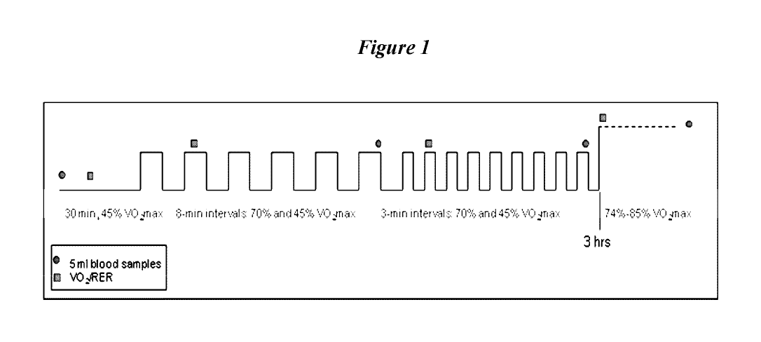

Three to five days after the VO₂max test, the subjects again reported to the laboratory to perform a familiarization ride, which also allowed verification and subsequent adjustment of the calculated workloads for the experimental trials. The familiarization ride followed the protocol as the experimental rides, except that no blood samples were collected, and only water was provided every 20 min. The protocol is shown in FIG. 1. The first 30 min of the protocol were at low intensity (45% VO₂max). For the next 1.5 h, the intensity alternated every 8 min between 45% and 70% VO₂max. From hour 2 to 3, the intensity continued to alternate between 45% and 70% VO₂max, but did so every 3 min. After the 3 h time point, the intensity increased to between 74% and 85% of VO₂max (exhaustion protocol), and this marked the start of the time to exhaustion determination. Subjects were encouraged to ride as long as possible while maintaining a pedaling cadence of 80 to 90 revolutions per minute (rpm). When they could no longer maintain a pedaling cadence of 60 rpm despite constant verbal encouragement, they were asked to stop, and time to exhaustion was recorded as min:sec beyond the 3 h point. Constant verbal encouragement was given to the subjects during each trial, and the same investigators were present during all trials for each subject so that encouragement was consistent across all trials. In addition, subjects were not aware of how long they rode each time, as all timing devices were removed from their line of sight or covered.

For all trials, the subjects arrived at the laboratory after an overnight, 12 h fast, during which only water was consumed. Upon arrival, body weight was obtained and a heart rate monitor (Polar Beat, Polar Electro, Oy, Finland) was secured in place around the subject's chest. For the experimental trials, subjects were catheterized (antecubital vein). A resting blood sample was taken, and then the subject was given the first dose of supplement to drink. After consuming the 275 ml beverage, the subject mounted the ergometer and the cycling protocol began. Supplements (275 ml) were provided every 20 min for the duration of the ride. If the subjects were able to ride longer than 40 min during the exhaustion portion of the protocol (i.e.; 40 min beyond the 3 h ride), and felt too full to continue to drink the entire amount of supplement provided each time, then they were asked to consume as much as they felt comfortable ingesting. During the exercise trials, the laboratory temperature was maintained at ˜21° C. and a fan was directed towards the subject to reduce thermal stress.

### Formulations

In the double-blinded, randomly-ordered experimental trials subjects consumed either a 6% carbohydrate beverage (CHO) or a 3% carbohydrate/1.2% protein (MCP; the performance formulation according to several embodiments of the invention) beverage. The CHO beverage consisted of dextrose, and the performance formulation contained dextrose, maltodextrin, and fructose (1% each), and a whey protein isolate. At the beginning of exercise and every 20 min thereafter, 275 ml of the selected beverage (CHO or performance formulation) was consumed. Human Performance Laboratories, LLC (Austin, Tex.) provided the beverages in powder form, and were mixed in the laboratory to the concentrations specified above. The energy and macronutrient content of the beverages are shown in Table 1. The beverages were similar in color, taste, and texture to allow a double-blinded and randomly ordered study design. A laboratory technician who was not involved in the data collection prepared the beverages for each trial.

TABLE 1
Nutrient Information of Formulations Tested (Per 100 ml. Both treatments
contained the same amounts of electrolytes Na⁺, K⁺, and Mg⁺⁺.

| | | | High- |
|---|---|---|---|
| | | Moderate | Carbohydrate + |
| | Carbohydrate | Carbohydrate + | High Protein |
| | Only | Protein (MCP) | (HCP) |
| Calories | 24 | 16.9 | 33.76 |
| % Total Carbohydrate | 6.0 | 3.0 | 6 |
| % Dextrose | 6 | 1 | — |
| % Fructose | — | 1 | — |
| % Maltodextrin | — | 1 | — |
| % Protein | — | 1.2 | 1.5 |
| Ratio | n/a | 2.5:1 | 4:1 |
| Carbohydrate to | | | |
| Protein | | | |
| Carbohydrate (g) | 6 | 3 | 6 |
| Protein (g) | — | 1.2 | 1.5 |

### Subjects

Fifteen trained endurance athletes (cyclists and triathletes) between the ages of 20 and 40 years were admitted to the study (8 males, 7 females). Subject characteristics are listed in Table 2. Written informed consent was obtained from all subjects, and the study was approved by The University of Texas at Austin Institutional Review Board.

TABLE 2
Subject Characteristics for Example 1 (Mean ± SEM).

| | | | | VO₂ max | VT |
|---|---|---|---|---|---|
| | | | | (L · | (L · |
| | Age (yr) | Mass (kg) | Height (cm) | min⁻¹) | min⁻¹) |
| Total, | 28.7 ± 1.2 | 65.9 ± 2.4 | 172.0 ± 2.2 | 3.70 ± .20 | 2.80 ± .20 |
| n = 15 | | | | | |
| Males, | 28.9 ± 1.9 | 69.2 ± 2.5 | 175.8 ± 2.0 | 4.50 ± .10 | 3.40 ± .10 |
| n = 8 | | | | | |
| Females, | 28.6 ± 1.5 | 62.1 ± 4.1 | 167.7 ± 3.6 | 2.90 ± .20 | 2.00 ± .20 |
| n = 7 | | | | | |
| At or | 29.5 ± 1.2 | 64.5 ± 2.5 | 172.6 ± 3.6 | 3.50 ± .30 | 2.70 ± .20 |
| below | | | | | |
| VT, n = 8 | | | | | |
| Above | 27.9 ± 2.2 | 67.4 ± 4.5 | 171.3 ± 2.6 | 4.00 ± .40 | 3.00 ± .30 |
| VT, n = 7 | | | | | |

### Ventilatory Threshold (Post Priori)

Post priori, data were filtered to determine if the intensity at which subjects cycled to exhaustion relative to their individual ventilatory thresholds contributed to the increases in time to exhaustion. Using the minute ventilation (V_{E}), VCO₂, and VO₂ data from the VO2max test, ventilatory threshold (VT) was calculated using a computer-generated plot (ParvoMedics TrueOne2400 software). VT was defined as the point at which the V_{E} (minute ventilation) increased in a nonlinear fashion compared to increases in VO₂ and was substantiated by an increase in the V_{E}/VCO₂ to V_{E}/VO₂ ratio.

### Results

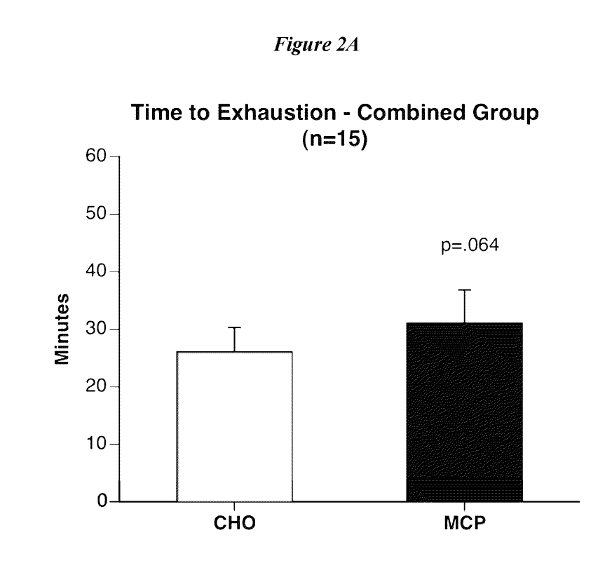

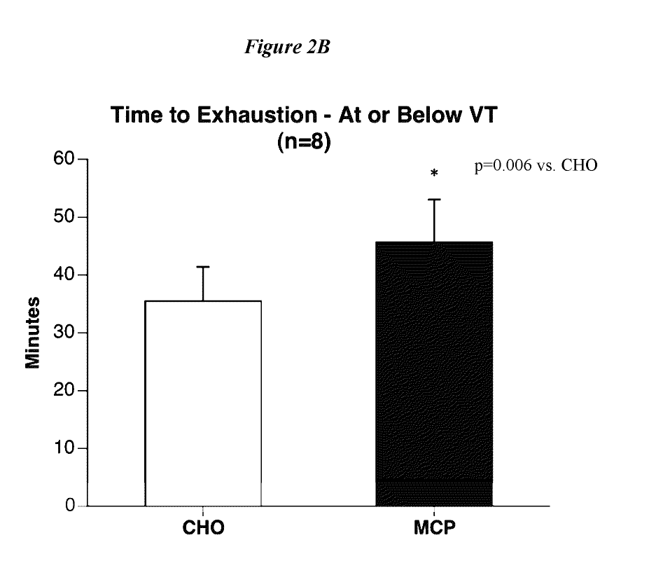

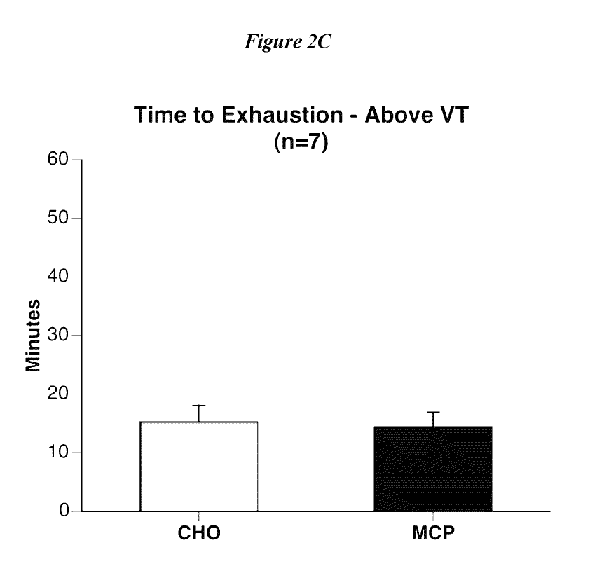

Consumption of the performance formulation did not appear to significantly alter time to exhaustion when all subjects were combined and evaluated together. For the combined group (n=15), subjects consuming the performance formulation cycled for 31.06±5.76 minutes as compared to 26.03±4.27 minutes for those consuming the CHO beverage. While statistical significance was not reached in this study, the p-value of 0.064 strongly suggests that the performance formulation may increase time to exhaustion. See FIG. 2A. However, after post priori separation of data based on VT, it was determined that time to exhaustion was significantly greater for those subjects exercising at or below VT. Grouped data indicate that subjects consuming CHO were able to cycle for 35.47±5.94 min while subjects consuming the performance formulation could cycle for 45.64±7.38 minutes (p=0.006). See FIG. 2B. In several embodiments, the time for which performance can be maintained prior to exhaustion (or drop in performance) is at least about 10% greater with a protein:carbohydrate beverage having a ratio of about 2.4 to 2.7:1 as compared to carbohydrate alone. In several embodiments, the increase is about 15% to about 20%, about 20% to about 25%, about 25% to about 30%, about 30% to about 35%, about 35% to about 40%, and overlapping ranges thereof. In some embodiments, the increase is about 2-fold, about 3-fold, about 4-fold, about 5-fold, or more. Thus, as discussed above, several embodiments of the performance formulation provide enhanced endurance during physical activity. Moreover, a clearly significant increase was detected when subjects were exercising at or below their VT. Most physical exertion occurs below VT and the majority of athletes (casual or elite/professional) spend a great deal of their exercise/training time at or below VT. Thus, several embodiments of the performance formulation are particularly advantageous because the enhanced hydration and endurance are achieved throughout the majority of exercise time. In other words, several embodiments of the performance formulations disclosed herein are particularly effective at extending endurance and delaying fatigue (as compared to a carbohydrate alone beverage) around the exercise intensity at which prolonged endurance performance is often crucial. In still additional embodiments, benefits may be gained when exercising above VT. For example, muscle damage, muscle recovery time, or other parameters may be positively affected by consumption of the MCP formulation, even if no increase in time to exhaustion is detected. Moreover, exhaustion is realized differently (and reached differently) in different activities. For example, in some activities, a prolonged but relatively steady level of activity leads to a gradual decrease in energy stores and eventual exhaustion. In other activities, a series of acute, high intensity efforts result in a step-wise depletion of energy stores. Thus, in several embodiments, increases in time to exhaustion are realized when exercising above VT are dependent on the manner in which VT was reached.

There were no significant differences in time to exhaustion for the above VT group (n=7); CHO, 15.25±2.83 vs. MCP, 14.39±2.50 min, p=0.8). See FIG. 2C. Because the ability to exercise for long periods near an individual's LT (or VT, or VO₂max) becomes a critical component of performance in long events such as marathons, longer cycling races and long-distance triathlons, some embodiments of the performance formulation are particularly advantageous. It is possible that other factors that contribute to exhaustion when exercising at higher intensities, such as a significant drop in muscle pH or depletion of high energy phosphates, may not be affected by the supplement in one embodiments according to the conditions tested. Other embodiments of the invention and/or other conditions may demonstrate enhanced effects above the VT.

Blood samples were analyzed for plasma insulin, plasma glucose, blood lactate and plasma myoglobin as described above.

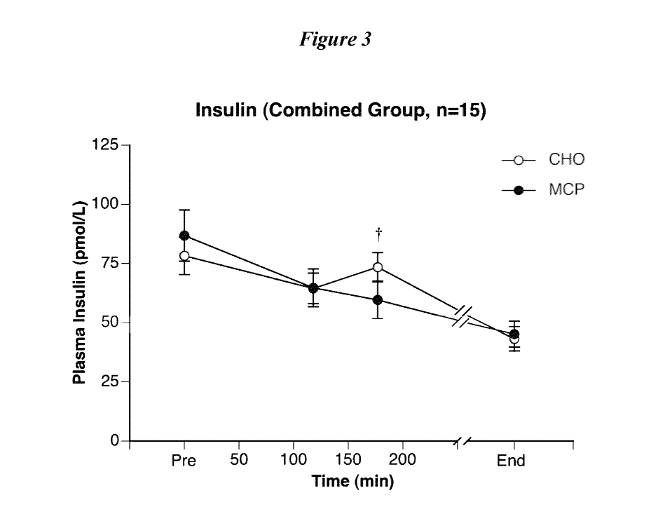

With respect to insulin levels, a significant treatment by time difference was observed at 177 min, with plasma insulin higher in the carbohydrate group as compared to the performance formulation in the combined group (p=0.023; see FIG. 3), as well as in at or below VT group (p=0.032). No significant differences in plasma insulin were found when exercise exertion was calculated to be above VT.

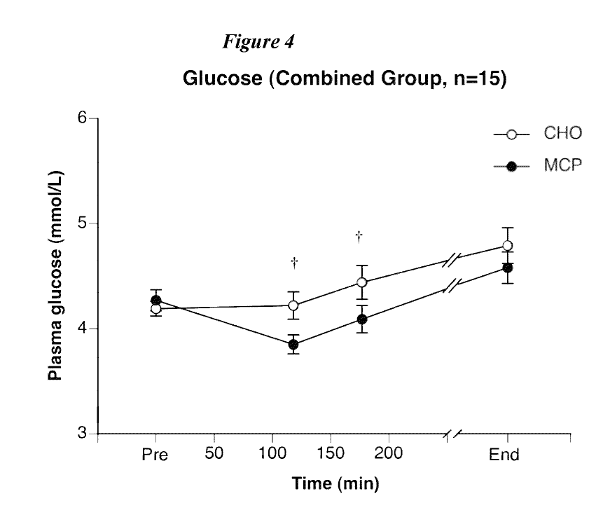

Plasma glucose was significantly lower in subjects ingesting performance formulation as compared to the carbohydrate-only consuming subjects (combined group; see FIG. 4). Significant treatment by time effects were also observed at minutes 118 and 177 (p=0.003 and 0.005, respectively). No treatment by time differences were found when grouped by VT.

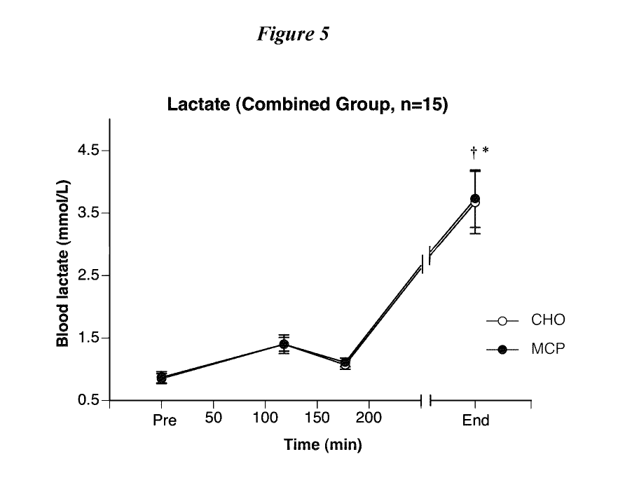

Blood lactate levels rose significantly during the time to exhaustion portion of the protocol (FIG. 5), but there were no differences between the treatments whether grouped or not grouped by VT. Other embodiments of the invention and/or alternate conditions may affect blood lactate.

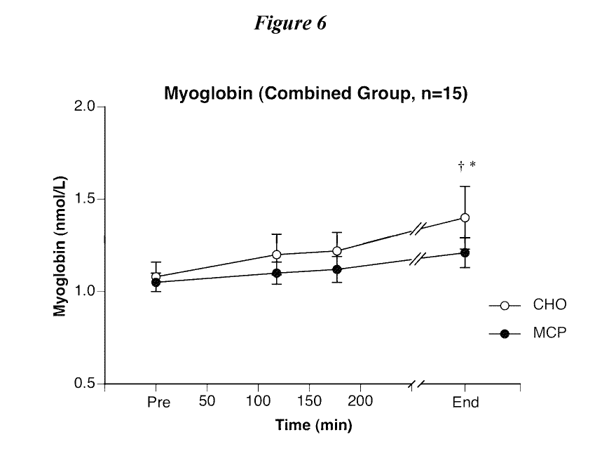

Plasma myoglobin levels rose during exercise in both treatments. Myoglobin appeared to be lower at End in subjects ingesting performance formulation (FIG. 6). A similar trend was found in the group exercising above VT.

Myoglobin was evaluated in the present study because it is a small molecule that leaks from the skeletal muscle cell early on during exercise when damage occurs, peaking in about 1 h post-exercise. In the combined group (FIG. 6), myoglobin levels continued to rise over the course of the trial with the CHO treatment, whereas with the performance formulation, myoglobin increased to a lesser but non-significant extent (p=0.189). These data suggest that several embodiments of the performance formulation would increase time to exhaustion as well as reduce muscle damage during exercise.

Table 3 depicts data collected for RPE and HR. No significant differences were detected for RPE or HR between treatments regardless of VT grouping. Thus in several embodiments, the performance formulation enhances endurance without inducing a perception of increased workload in the individual, and without significantly increasing heart rate. In some embodiments, however, significant increases in time to exhaustion are obtained after consuming the performance formulation while one or more of RPE or HR increases.

TABLE 3
Rating of Perceived Exertion and Heart Rate in Response to Consumption of
Performance Formulation or Carbohydrate-only Formulation. (Mean ± SEM)

| | | | Performance Formulation | | | Carbohydrate Only | | |
|---|---|---|---|---|---|---|---|---|
| | | | Combined | | | Combined | | |
| | Intensity | Min | Group | =/<VT | >VT | Group | =/<VT | >VT |
| RPE | Low | 90 | 11 ± .31 | 12 ± .46 | 11 ± .40 | 11 ± .33 | 11 ± .36 | 11 ± .57 |
| | Low | 130 | 12 ± .28 | 12 ± .50 | 11 ± .20 | 12 ± .30 | 12 ± .53 | 11 ± .18 |
| | Low | 161 | 12 ± .35 | 12 ± .55 | 12 ± .43 | 12 ± .33 | 12 ± .44 | 11 ± .41 |
| | High | 115 | 14 ± .22 | 14 ± .27 | 13 ± .36 | 14 ± .31 | 14 ± .38 | 14 ± .53 |
| | High | 159 | 14 ± .34 | 14 ± .31 | 14 ± .65 | 14 ± .37 | 14 ± .45 | 14 ± .61 |
| | High (TTE) | 184 | 16 ± .32 | 16 ± .41 | 16 ± .53 | 16 ± .30 | 16 ± .42 | 16 ± .43 |
| HR | Low | 90 | 119.4 ± 3.3 | 121.9 ± 5.1 | 116.6 ± 4.0 | 120.9 ± 2.9 | 123.9 ± 3.8 | 117.4 ± 4.5 |
| | Low | 130 | 124.9 ± 3.3 | 126.8 ± 4.9 | 122.9 ± 4.6 | 127.6 ± 3.8 | 130.6 ± 5.7 | 124.1 ± 5.0 |
| | Low | 161 | 130.0 ± 3.5 | 129.4 ± 5.2 | 130.7 ± 5.2 | 132.1 ± 3.5 | 134.0 ± 5.0 | 129.9 ± 5.1 |
| | High | 115 | 143.7 ± 4.2 | 143.5 ± 7.0 | 144.0 ± 4.9 | 148.7 ± 3.9 | 148.8 ± 5.7 | 148.6 ± 5.7 |
| | High | 159 | 145.1 ± 4.3 | 143.5 ± 7.2 | 147.0 ± 4.5 | 149.3 ± 3.5 | 149.4 ± 4.9 | 149.1 ± 5.3 |
| | High (TTE) | 184 | 162.7 ± 3.8 | 160.5 ± 5.8 | 165.3 ± 4.9 | 162.9 ± 3.7 | 160.5 ± 5.2 | 165.6 ± 5.5 |

No significant treatment differences were detected in either carbohydrate oxidation rate or fat oxidation rate (g/min) between MCP and CHO whether grouped or not grouped by VT (see Table 4).

TABLE 4
Substrate Utilization in Response to Consumption of Performance
Formulation of Carbohydrate-only Formulation. (Mean ± SEM)

| | | Performance Formulation | | | Carbohydrate Only | | |
|---|---|---|---|---|---|---|---|
| | | Combined | | | Combined | | |
| Substrate | Intensity | Group | =/<VT | >VT | Group | =/<VT | >VT |
| CHO | Low | 1.50 ± .11 | 1.44 ± .12 | 1.59 ± .20 | 1.54 ± .11 | 1.47 ± .13 | 1.64 ± .19 |
| (g · min−1) | High | 2.67 ± .19 | 2.53 ± .24 | 2.84 ± .30 | 2.70 ± .19 | 2.50 ± .23 | 2.94 ± .30 |
| | High/TTE | 3.56 ± .25 | 3.18 ± .29 | 3.99 ± .38 | 3.65 ± .27 | 3.25 ± .31 | 4.11 ± .40 |
| Fat | Low | 0.24 ± .03 | 0.22 ± .03 | 0.28 ± .06 | 0.21 ± .02 | 0.20 ± .02 | 0.23 ± .04 |
| (g · min−1) | High | 0.19 ± .03 | 0.18 ± .05 | 0.23 ± .06 | 0.17 ± .03 | 0.17 ± .05 | 0.17 ± .04 |
| | High/TTE | 0.06 ± .02 | 0.08 ± .04 | 0.05 ± .03 | 0.02 ± .02 | 0.05 ± .03 | 0.00 ± .00 |

### Example 2

### Effect of Moderate Carbohydrate-Protein Formulation on Exercise Performed at or Below Ventilatory Threshold

### General

A randomized, double-blinded, repeated measures study was performed to evaluate the effects of ingestion of a moderate carbohydrate-protein formulation on exercise performed at or below ventilatory threshold. The subjects tested were fourteen female cyclists and triathletes. The University of Texas at Austin Institutional Review Board approved the study before it commenced. Subject characteristics are found in Table 5.

TABLE 5
Subject Characteristics for Example 2 (Mean ± SEM)

| | | | Height | VO₂max | VO₂max | V_{T} |
|---|---|---|---|---|---|---|
| | Age (yr) | Mass (kg) | (cm) | (L · min⁻¹) | (mL · kg⁻¹ · min⁻¹) | (L · min⁻¹) |
| Females | 30.4 ± 1.6 | 61.5 ± 2.2 | 167 ± 2.7 | 2.90 ± 0.15 | 46.74 ± 1.6 | 2.23 ± 0.13 |
| (N = 14) | | | | | | |

As discussed above, subject completed an initial VO₂max test and familiarization trial, then performed two experimental trials in order to test the effect of one embodiment of the performance formulation disclosed herein (mixed 3% carbohydrate supplement with 1.2% added protein; CHO+PRO), against a traditional 6% carbohydrate (CHO) supplement. See Table 1 for the formulations. Familiarization trials were performed as described above.

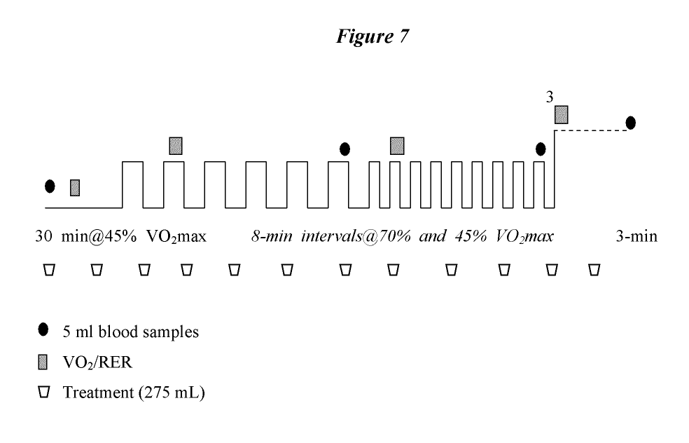

The cycling protocol consisted of varying intervals between 45% and 70% VO₂max, followed by a ride to exhaustion at an exercise intensity approximating the individual's VT. The first 30-min of cycling was conducted at 45% VO₂max, followed by six intervals of 8-min duration. Interval duration was then reduced to 3-min. At 3 hours into the cycling protocol, subjects began the performance ride at an intensity relative to their VT, and this intensity was held until exhaustion. Refer to FIG. 7 for cycling protocol. Exhaustion was determined as the point at which subjects could no longer maintain a pedaling cadence of 60 revolutions per minute (rpm), despite constant verbal encouragement.

Supplements (275 ml) were consumed immediately prior to commencing the trial, and every 20 minutes thereafter. Supplement compositions are shown in Table 1, were supplied by the Human Performance Laboratory (Austin, Tex.), and were prepared by a laboratory technician not directly involved in the study. All supplements were similar in taste, color and texture.

Respiratory measures, blood samples, heart rate and time to exhaustion were measured as described above.

### Results

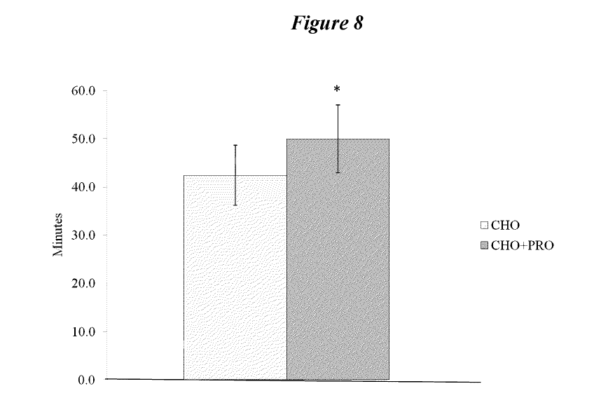

Confirming the post-priori data separation discussed in Example 1 above, cyclists that consumed the performance formulation and exercised at or below their VT were able to ride significantly longer than those consuming a carbohydrate alone supplement. Performance formulation subjects road for 49.94±7.01; a 15.2% increase in performance in comparison to carbohydrate consuming subjects, who rode for 42.36±6.21 minutes, p<0.05). See FIG. 8. Thus, as discussed above, in several embodiments consumption of the performance formulation improves performance by at least about 5%, at least about 10%, at least about 15%, at least about 20% or more. Subjects performed the exhaustion ride at an average of 75.06% VO2max, ˜1.5% lower than the calculated average group VT (76.57±1.24% VO2max). Intensities for individual subjects ranged from 7.25% below VT to 5.1% above VT. Thus, these results indicate that several embodiments of the performance formulation are particularly effective at enhancing performance and/or endurance. In particular, several embodiments of the performance formulation significantly increase performance and/or endurance at exercise intensities that are at or below an individuals VT, a level of exertion which is most commonly attained during exercising. Several embodiments of the performance formulation are particularly advantageous because the increase in endurance was achieved by ingestion of 50% fewer carbohydrates and approximately 30% fewer calories. Such embodiments may be preferred by individuals concerned about body weight, body composition, and/or caloric intake. As shown in the present example (as well as others), improved performance is often realized as an increase in the time to exhaustion. The time to exhaustion represents a time period during which an athlete can perform at their maximum effort, after a period of non-maximal effort. In effect, increased time to exhaustion represents an increase in endurance. However, in several embodiments, benefits of consuming the performance formulation are recognized outside the context of endurance events or activities. For example, in several embodiments, consumption of the performance formulation is beneficial in short, high intensity activities (sprinting, short running events (e.g., 5K or 10K), or short distance swimming are non-limiting examples). As discussed above, the performance formulation allows an individual's body to preferentially use of exogenous glucose, rather than endogenous stores. In the same way that the use of exogenous glucose spares the endogenous stores, the use of exogenous glucose provides an immediate source of energy for intensely working muscles. Thus, there is little to no delay from the time at which a muscle begins activity to the time at which exogenous glucose is available. Thus, while several embodiments of the performance formulation provide increased endurance performance, several embodiments also provide a benefit for shorter, more intense activities. Moreover, such intense activities often are associated with greater degrees of muscle damage (due to the intensity), which, in some embodiments, is reduced by virtue of consuming the performance formulation.

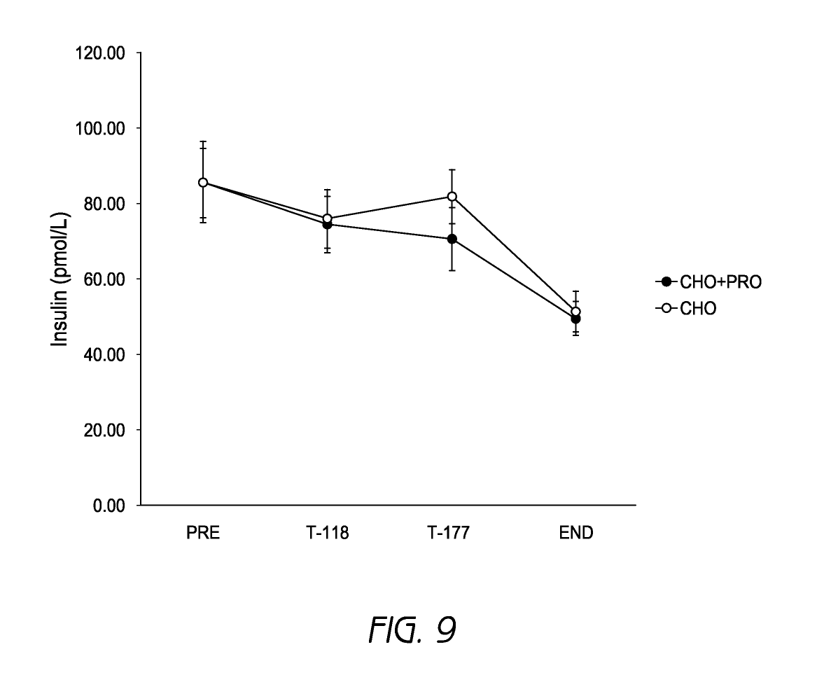

Plasma insulin levels decreased as exercise time increased, however there was no significant differences between treatments. See FIG. 9. Average plasma insulin was 73.56±7.37 pmol·L⁻¹ during the CHO trial and 70.00±7.78 pmol·L⁻¹ during the CHO+PRO trial.

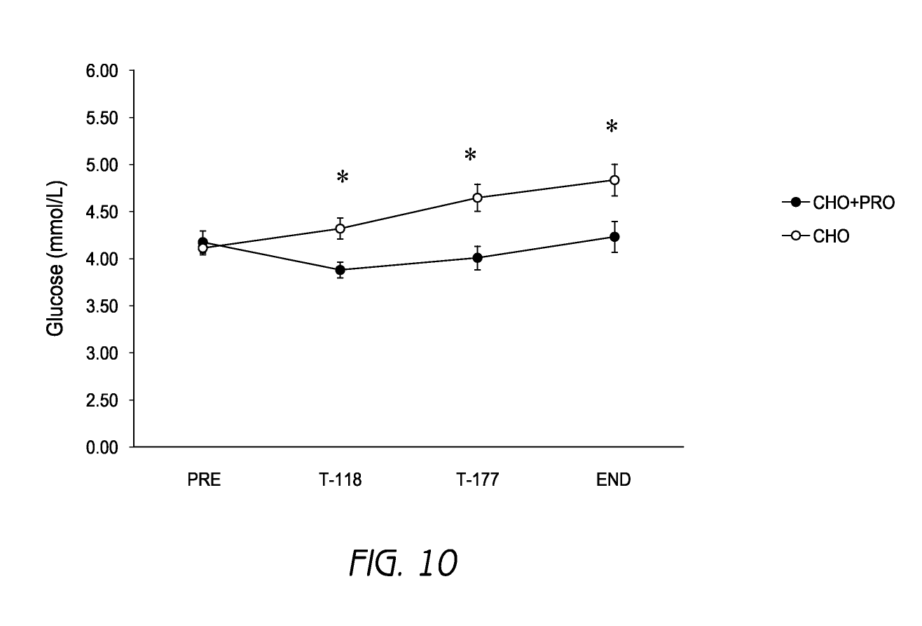

No significant differences were detected between treatment groups in pre-exercise plasma glucose levels. Glucose levels remained fairly constant over time in the performance formulation group, with glucose dropping slightly at 118-min (as compared to pre-exercise levels). In contrast, plasma glucose levels increased significantly from PRE to END in the carbohydrate only group. Additionally, mean blood glucose for carbohydrate only group (4.47±0.12 mmol·L⁻¹) was significantly greater than for the performance formulation group (4.07±0.12 mmol·L⁻¹) with treatment by time differences occurring at minutes 118 and 177, and at the point of exhaustion (p<0.05). See FIG. 10. These insulin/glucose data suggest that certain embodiments of the performance formulation yield increased endurance by increasing glucose clearance from the blood at a greater rate than carbohydrate beverages alone, resulting in lower blood glucose levels and increased exogenous carbohydrate availability to the working muscle. In other words, the composition of the performance formulation appears to preferentially utilize the recently ingested carbohydrates, thereby sparing the endogenous carbohydrates for use as a longer term energy supply.

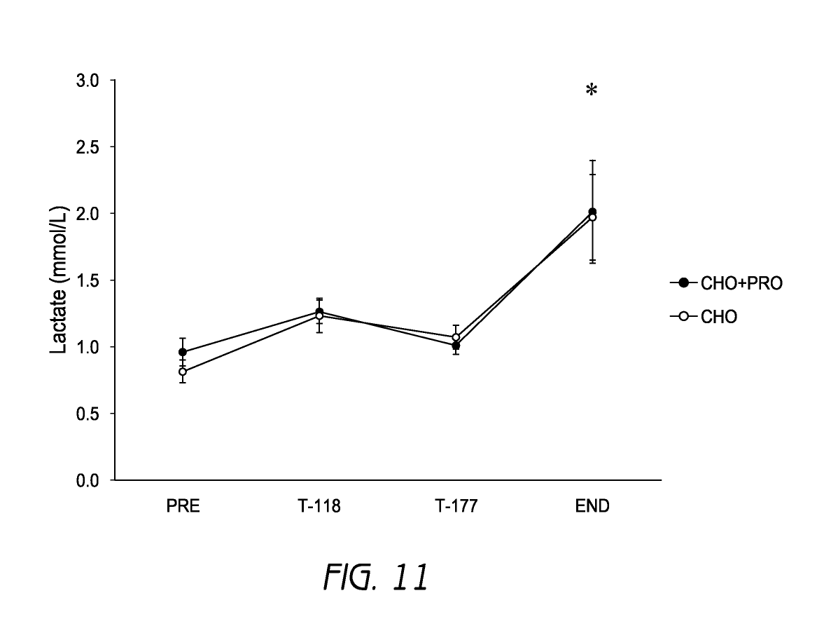

Average blood lactate concentration was 1.21±0.139 mmol·L⁻¹ for the carbohydrate only group and 1.22±0.147 mmol·L⁻¹ for performance formulation group. While no significant differences were detected between treatments groups or based on treatment by time, both groups displayed a significant increase in blood lactate concentration between the 177 minute time-point and the end of the trial. See FIG. 11, significance depicted by “*”. Increased lactate is a primary contributor to the “burn” experienced by fatigued muscles. Thus, increased lactate during the time to exhaustion trial in all groups would appear to be a normal response. Several embodiments of the performance formulation are advantageous during both short and extended periods of exertion due to providing a maintenance effect on the formation of lactate, which may be one factor contributing to the increased endurance of those consuming the performance formulation.

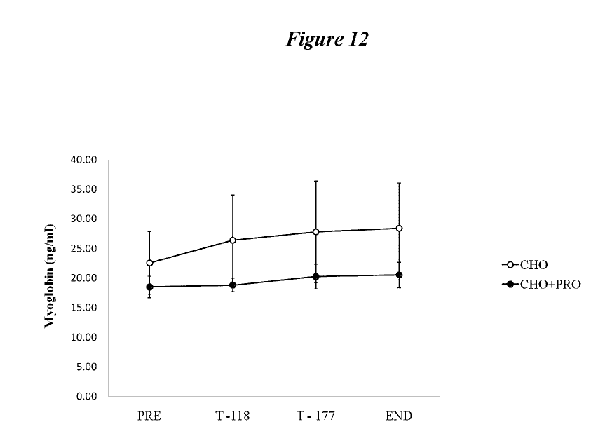

Average plasma myoglobin concentration remained relatively steady over time within the groups (average of 26.28±7.28 ng·ml⁻¹ in the carbohydrate only group and average of 19.64±1.79 ng·ml⁻¹ in the performance formulation group). Statistical analysis revealed no significant overall difference in treatment or treatment by time interaction for myoglobin. See FIG. 12.

Average respiratory exchange ratio (RER) of carbohydrate only subjects over the first three hours ride was 0.924±0.011 and 0.939±0.012 for subjects in the performance formulation group. See Table 6. Oxygen consumption (VO2) over the same period was slightly, but significantly higher in the performance formulation group (1.779 L/min) as compared to the carbohydrate only group (1.755±0.09 L/min, p<0.05). Carbohydrate and fat utilization were calculated from VO2, VCO2, and RER data. Average carbohydrate oxidation during the during the 3 hour variable intensity ride was 1.76±0.12 g·min−1 for the carbohydrate only group and 1.75±0.12 g·min−1 for the performance formulation group. Average fat oxidation for the carbohydrate only group and performance formulation group were 0.24±0.04 g/min and 0.22±0.04 g/min respectively. No significant treatment differences in either carbohydrate or fat oxidation rates (g/min) were calculated between groups. However, in several embodiments, as discussed above, the type of carbohydrate used (e.g., exogenous carbohydrates preferentially used versus endogenous carbohydrates which are spared) is different and results in improved performance.

TABLE 6
Respiratory Exchange Ratio and Substrate Utilization for Subjects Exercising
At or Below VT and Consuming Either Carbohydrate Only or Performance Formulation

| | | | | |
|---|---|---|---|---|
| 10 min | 50 min | 130 min | 135 min | 184 min |

RER

| | | | | | |
|---|---|---|---|---|---|
| CHO + PRO | 0.90 ± 0.01 | 0.93 ± 0.01 | 0.91 ± 0.01 | 0.91 ± 0.01 | 0.96 ± 0.01 |
| CHO | 0.89 ± 0.01 | 0.93 ± 0.01 | 0.91 ± 0.01 | 0.92 ± 0.01 | 0.97 ± 0.02 |

Carbohydrate Utilization (g/min)

| | | | | | |
|---|---|---|---|---|---|
| CHO + PRO | 1.16 ± 0.07 | 1.98 ± 0.14 | 1.23 ± 0.06 | 1.85 ± 0.13 | 2.51 ± 0.18 |
| CHO | 1.12 ± 0.07 | 2.01 ± 0.15 | 1.26 ± 0.07 | 1.86 ± 0.13 | 2.55 ± 0.17 |

Fat Utilization (g/min)

| | | | | | |
|---|---|---|---|---|---|
| CHO + PRO | 0.23 ± 0.03 | 0.25 ± 0.05 | 0.22 ± 0.03 | 0.29 ± 0.05 | 0.19 ± 0.05 |
| CHO | 0.24 ± .03 | 0.23 ± 0.04 | 0.20 ± 0.02 | 0.28 ± 0.04 | 0.16 ± 0.04 |

During exercise, average heart rate was significantly lower in the performance formulation group (130.17±3.13 bpm) as compared the carbohydrate only group (132.80±2.92 bpm, p<0.05). Thus, several embodiments of the performance formulation lead to enhanced endurance with a lower heart rate, thereby indicating an increase in cardiac efficiency with the performance formulation. No significant differences were detected between treatments for RPE. See Table 7. Several embodiments of the performance formulation, are therefore particularly advantageous because the increase in endurance is achieved in the absence of a perception of increased workload.

TABLE 7
Heart Rate and RPE for Subject Exercising At or Below VT and Consuming Either Carbohydrate Only Formulation or Performance Formulation

| Low Intensity (45% VO2max) | | | | High Intensity (70% VO2max) | | | |
|---|---|---|---|---|---|---|---|
| 25 min | 90 min | 130 min | 161 min | 50 min | 115 min | 159 min | 184 min |

Heart Rate (BPM)

| | | | | | | | | |
|---|---|---|---|---|---|---|---|---|
| CHO + PRO | 111.79 ± 2.60 | 117.79 ± 2.89 | 123.29 ± 2.65 | 127.21 ± 3.62 | 138.57 ± 2.24 | 139.57 ± 3.57 | 138.79 ± 3.14 | 151.00 ± 3.48 |
| CHO | 113.29 ± 2.65 | 121.64 ± 2.55 | 124.00 ± 3.26 | 128.93 ± 3.20 | 141.43 ± 2.46 | 144.86 ± 3.28 | 143.50 ± 3.14 | 151.00 ± 3.48 |

Rating of Perceived Exertion

| | | | | | | | | |
|---|---|---|---|---|---|---|---|---|
| CHO + PRO | 9.36 ± 0.44 | 11.57 ± 0.27 | 11.93 ± 0.32 | 12.00 ± 0.41 | 12.57 ± 0.25 | 13.50 ± 0.23 | 13.36 ± 0.44 | 15.04 ± 0.32 |
| CHO | 8.82 ± 0.42 | 11.93 ± 0.50 | 11.89 ± 0.29 | 12.07 ± 0.34 | 11.93 ± 0.50 | 13.46 ± 0.31 | 14.04 ± 0.40 | 15.21 ± 0.38 |

### Example 3

### Effects of Moderate Carbohydrate-Protein Formulation on Exercise Performed Versus High Carbohydrate-Protein and Carbohydrate Only Formulations

As discussed above, consumption of a formulation having unbalanced addition of carbohydrates, protein, or other nutrients may adversely impact performance. The gastric system may be sensitive to the amount of certain nutrients in an ingested formulation, particularly when a subject is engaged in physical activity at the time. Supplements having high protein levels and/or high carbohydrate levels may adversely affect the gastric system, thereby reducing the absorption of portions of the beverage. As a result, such “mis-optimized” beverages may hinder both hydration and performance, despite being marketed as enhancing both.

To evaluate the advantages of the formulations of several embodiments of the invention, a preliminary study was performed that compared the effects of one embodiment of the performance formulation (carbohydrate to protein ratio of approximately 2.5:1; MCP) with formulations having either an approximate 4:1 ratio (HCP) or a carbohydrate-only formulation. The subjects tested included 10 competitive cyclists who are accustomed to cycling for prolonged periods (3-5 h). They were between the ages of 19 and 33 years old. Each subject completed three randomly assigned treatments in which either the “Carb-Only”, the “2.5 ratio” drink, or the “4.0 ratio” drink was provided during exercise. Studies were performed as described above in Example 1.

In the study, the “Carb-only” drink and the performance formulation was prepared as described above. The HCP drink comprised a 5.9% carbohydrate blend with 1.4% protein. As with the Examples discussed above, the performance formulation was lower in calories than the other two drinks.

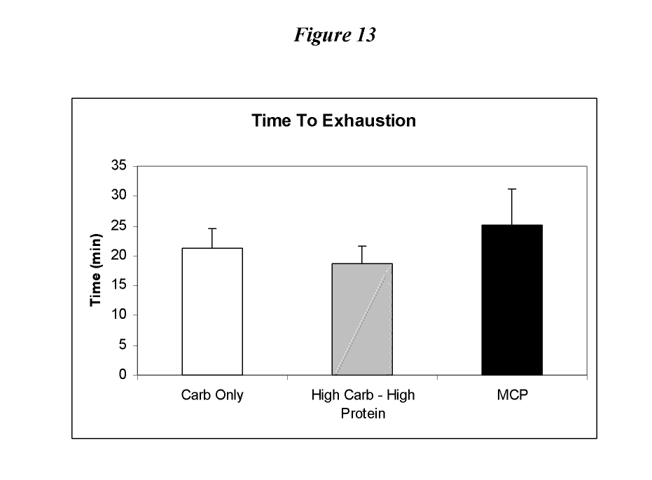

After performing the initial cycling trial while consuming one of the three formulation, subjects rode until exhaustion. The time to exhaustion was longer in those subjects consuming the performance formulation (see MCP in FIG. 13). Cyclists consuming the carbohydrate only formulation were able to ride for 21.17±3.3 minutes until exhaustion, those consuming the “4.2 ratio” drink: rode for 18.75±2.8 minutes until exhaustion. In contrast, those consuming the performance formulation were able to ride for 25.04±6.1 minutes until exhaustion, an 18% increase compared to the “Carb-Only” drink, and a 33% increase over the “4.2 ratio” drink. Thus, as discussed above, in several embodiments, the performance formulation increases performance by about 5% to about 25% (including about 5% to about 10%, about 10% to about 15%, about 15% to about 20%, about 20% to about 25%, about 25% to about 30%, about 30% to about 35%, and overlapping ranges thereof), as compared to carbohydrate alone (further reinforcing the data above) as well as compared to a high protein to carbohydrate drink. Thus, a “more is better” approach is less than ideal, in certain circumstances. The additional gastric workload presented by a high protein formulation may adversely affect the uptake of the protein and/or the carbohydrates consumed, thereby reducing the availability of exogenous glucose for use by active muscles. Thus, as discussed herein, the balanced amounts of protein and multiple types of carbohydrate used in several embodiments of the performance formulation lead to improved performance.

Further review of the data, based on individual riders, indicated that 6 of the 10 subjects exhibited superior performance when provided with the performance formulation drink Average times to fatigue were as follows:
MCP Performance formulation: 35.0 minutes;
“Carb-Only” drink: 25.2 minutes; and
HCP drink: 22.7 minutes.

Accordingly, with the performance formulation drink, which was prepared in accordance with several embodiments disclosed herein, physical performance (in terms of increased time to fatigue) was enhanced.

Therefore, this data suggests that several embodiments of the formulations disclosed herein, (e.g., the exercise performance formulations) offer benefits over other types of sports drinks. Moreover, these benefits occur despite the lesser caloric content of the performance formulation. Caloric content of the formulations tested are shown in Table 1. Thus, in accordance with several embodiments of the invention, the performance formulation, prepared according to several embodiments disclosed herein offers enhanced performance with fewer calories. This reduced caloric value and/or the reduced sugar content of certain embodiments of the performance formulation are particular advantages of several embodiments of the invention.

Moreover, contrary to certain claims of other carbohydrate and protein-containing beverages known in the art, these data demonstrate that a carbohydrate to protein ratio of less than 2.8 is unexpectedly beneficial to enhancing the performance of the subject. Thus, in accordance with several embodiments of the formulations disclosed herein, it is not the simple addition of more carbohydrate and more protein that benefits the consumer, but the balanced addition of carbohydrates relative to protein, in accordance with several embodiments disclosed herein that enhances performance.

### Example 4

### Effects of Moderate Carbohydrate-Protein Formulation on Exercise Performed Versus High Carbohydrate-Protein and Carbohydrate Only Formulations

To further elucidate the advantages of several embodiments of the formulations disclosed herein a more complete evaluation was made that compared one embodiment of the performance formulation disclosed herein (MCP) with formulations having either a 4:1 carbohydrate to protein ratio (HCP) or a carbohydrate-only formulation (CHO). Subjects included sixteen trained endurance athletes (cyclists and triathletes) between the ages of 20 and 40 years (8 males, 8 females) under written informed consent. Beverage formulations and cycling trials were prepared and performed as discussed above.

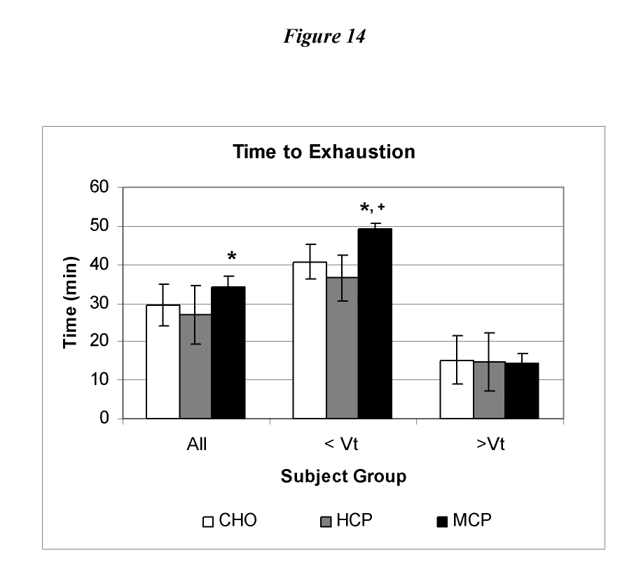

As shown in FIG. 14, the time to exhaustion of subjects consuming the performance formulation (MCP) disclosed herein was significantly greater than that of the subjects consuming a higher carbohydrate—higher protein formulation (HCP). (34.04±6.15 min versus 27.01±4.37 min; p<0.05). There was a clear trend indicating the MCP also improved time to exhaustion as compared to the CHO group (data which was clearly demonstrated in Examples 1 and 2).

As discussed above, exercise intensity is also an important factor in gauging the efficacy of a performance or recovery formulation. As shown in FIG. 14, when data were grouped by ventilatory threshold, the MCP formulation significantly enhanced time to exhaustion as compared to both HCP and carbohydrate only formulations.

This suggests the high ratio of carbohydrate and/or protein adversely impacted the overall beneficial effect of the beverage on performance. To avoid this effect, several embodiments of the formulations disclosed herein have an optimal protein to carbohydrate ratio. In several embodiments, that ratio is about 2.5:1 (e.g., 2.4 to 2.7 to 1), whereas the HCP beverage had a ratio of 4:1. The optimized carbohydrate to protein ratio in the performance formulation, in several embodiments, effectively stimulates carbohydrate uptake without adversely impacting gastric emptying rates or palatability. As such, water absorption and energy for active muscles is increased, and in some embodiments, recovery of muscle tissue and hydration post-activity is enhanced.

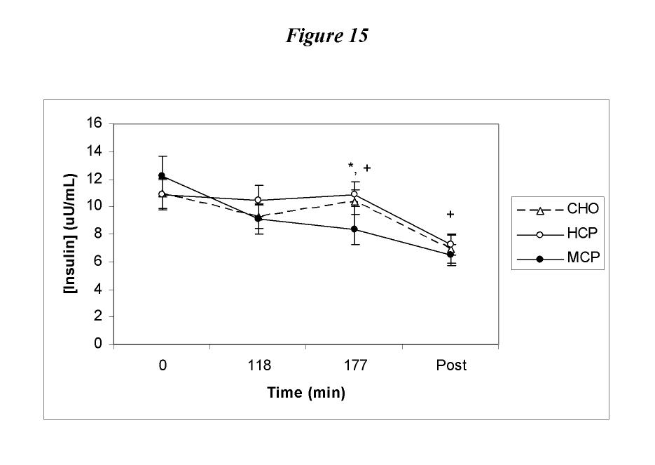

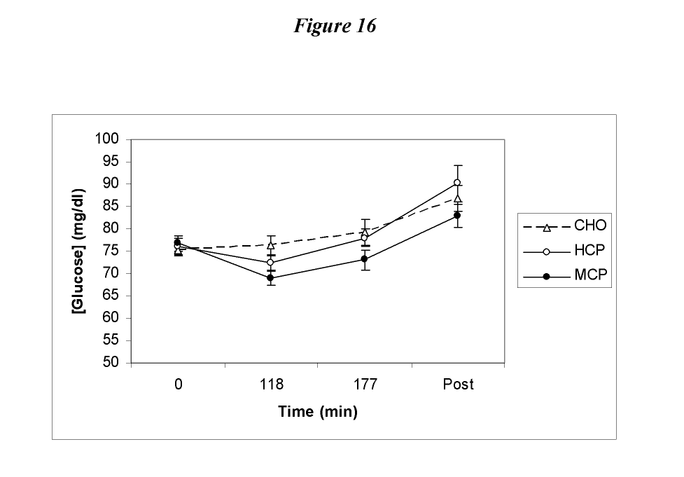

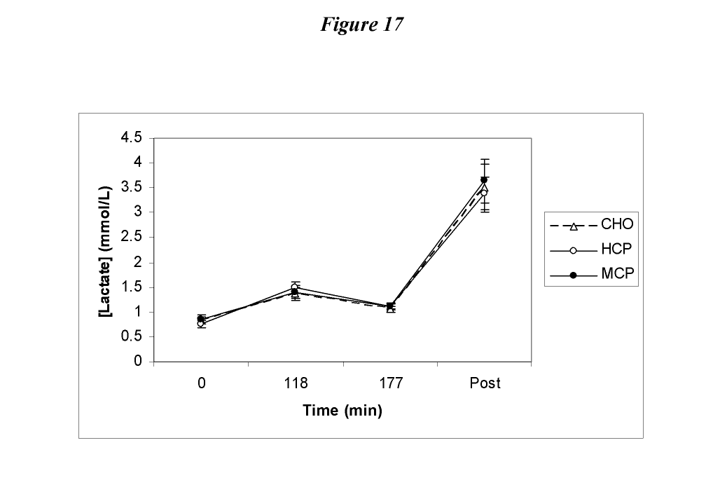

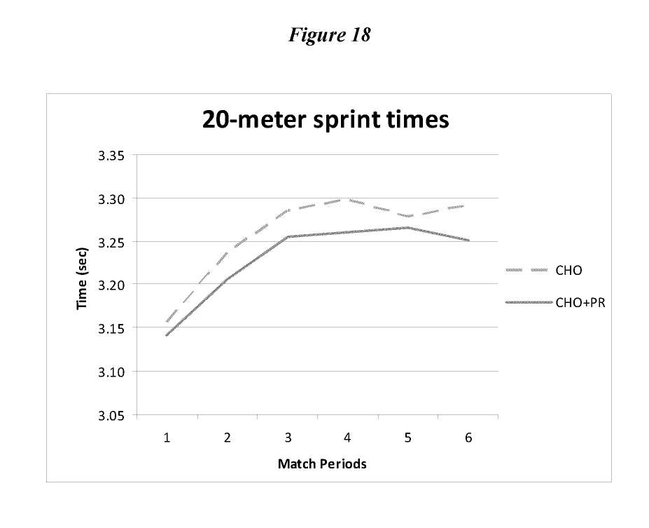

Insulin levels were significantly lower in subjects ingesting the performance formulation at Time=177 and at the end of the cycling trial. See FIG. 15. Despite the difference in insulin at these times, glucose was not significantly different between the groups at any time. See FIG. 16. No significant differences were detected in lactate. See FIG. 18. This demonstrates that the ingested formulations have a differential effect on insulin secretion, but no significant difference in glucose uptake is realized between the subjects consuming any of the formulations. Thus, certain embodiments of the performance formulation disclosed herein induce a more efficient insulin/glucose response (e.g., less insulin release yielding an equivalent amount of glucose uptake).

In several embodiments, this increased efficiency of the insulin/glucose response works in concert with other aspects of the performance formulation to provide the beneficial increase in performance. For example, in several embodiments, the mixture of carbohydrate types (e.g., dextrose, fructose, and maltodextrin, or combinations thereof) exploits carbohydrate transporters other than those of the glucose transporter family. Thus, for a given amount of carbohydrate ingested, multiple routes of carbohydrate uptake are used in parallel, which improves overall uptake. In some embodiments, this is advantageous because parallel uptake mechanism reduce the amount of carbohydrate that is retained in the gastrointestinal tract after consumption of the formulation. If consumed during exercise, this may reduce the “full” feeling that a consumer would experience. Moreover, reduced intestinal carbohydrate build-up may reduce activation of the parasympathetic nervous system, which could be counterproductive during periods of exercise/activity. In several embodiments, the amino acids present in the protein portion of the formulation aid in glucose uptake by non-insulin mediated mechanisms. In conjunction with insulin-mediated mechanisms, the overall glucose uptake is enhanced in several embodiments. Thus, the various mechanisms employed in taking up carbohydrates and protein from ingested performance formulation, and thereby supplement the increased efficiency of insulin/glucose signaling induced by the performance formulation are particularly advantageous in late timepoints during endurance activities.

Substrate oxidation was also measured for subjects in each group. (See Table 8) Throughout the protocol, subjects consuming the CHO and HCP formulations appeared to utilize a greater percent of carbohydrates (and less protein) than those subjects consuming the performance formulation. Carbohydrate utilization was significantly lower at 130 min, 135 min, and 184 min (end). This greater reliance on carbohydrate by the CHO and HCP groups suggests, as discussed above, that the consumption of the MCP beverage allows for endogenous carbohydrate sparing, thus allowing a “reserve” of carbohydrate-based energy that was recruited during the end of the trial and, at least in part, contributed to the longer time to exhaustion in the MCP group. Moreover, throughout the majority of the trial, the MCP subjects burned a greater proportion of fat, which is a rich source of energy. Thus, the performance formulation in accordance with several embodiments disclosed herein is advantageous for enhancing endurance either alone (advantageous for endurance athletes), or in combination with increased fat consumption (advantageous for maintenance or loss of weight).

TABLE 8
Calories Burned and Substrate Utilization in Subjects Consuming Either
Carbohydrate Only Formulation, High Carbohydrate-High Protein Formulation or
Performance Formulation

| | | | | |
|---|---|---|---|---|
| 10 min | 50 min | 130 min | 135 min | 184 min |

kcal/min

| | | | | | |
|---|---|---|---|---|---|
| CHO | 4.95 ± 0.01 | 5.01 ± 0.01 | 4.96 ± 0.01 | 4.98 ± 0.01 | 5.03 ± 0.01 |
| HCP | 4.96 ± 0.01 | 5.02 ± 0.01 | 4.97 ± 0.01 | 5.00 ± 0.01 | 5.04 ± 0.00 |
| MCP | 4.96 ± 0.01 | 5.01 ± 0.01 | 4.94 ± 0.01 | 4.98 ± 0.01 | 5.03 ± 0.01 |

Carbohydrate Utilization (g/min)

| | | | | | |
|---|---|---|---|---|---|
| CHO | 1.49 ± 0.11 | 2.81 ± 0.2 | 1.56 ± 0.11 | 2.51 ± 0.16 | 3.59 ± 0.26 |
| HCP | 1.51 ± 0.12 | 2.83 ± 0.21 | 1.64 ± 0.11 | 2.65 ± 0.18 | 3.61 ± 0.24 |
| MCP | 1.51 ± 0.12 | 2.77 ± 0.19 | 1.45 ± 0.09* | 2.48 ± 0.17* | 3.48 ± 0.25* |

Fat Utilization (g/min)

| | | | | | |
|---|---|---|---|---|---|
| CHO | 0.21 ± 0.02 | 0.12 ± 0.03 | 0.21 ± 0.02 | 0.22 ± 0.03 | 0.03 ± 0.02 |
| HCP | 0.2 ± 0.02 | 0.11 ± 0.03 | 0.19 ± 0.02 | 0.19 ± 0.03 | 0.02 ± 0.01 |
| MCP | 0.21 ± 0.02 | 0.14 ± 0.03 | 0.28 ± 0.04* | 0.26 ± 0.04* | 0.07 ± 0.02* |

### Example 5

### Effects of Moderate Carbohydrate-Protein Formulation on Soccer Endurance

In order to assess the efficacy of several embodiments of the formulations disclosed herein outside of the traditional endurance tests previously used (e.g., cycling trials to exhaustion), additional experiments were performed using simulated soccer matches. “Matches” comprised six timed periods separated by a halftime period (rest). Subject consumed either a carbohydrate only (6%, as described above) beverage or one embodiment of the performance formulation (CHO+PRO; as described above). See Table 1 for nutritional content. The formulations were consumed before the start of the “match” and at a “halftime”. During the six periods of the match subjects ran at varying speeds. At the conclusion of each period, subjects were evaluated with respect to sprint time over a 20 meter distance at 100% effort. At the conclusion of the match, subjects performed a run-time to exhaustion test.

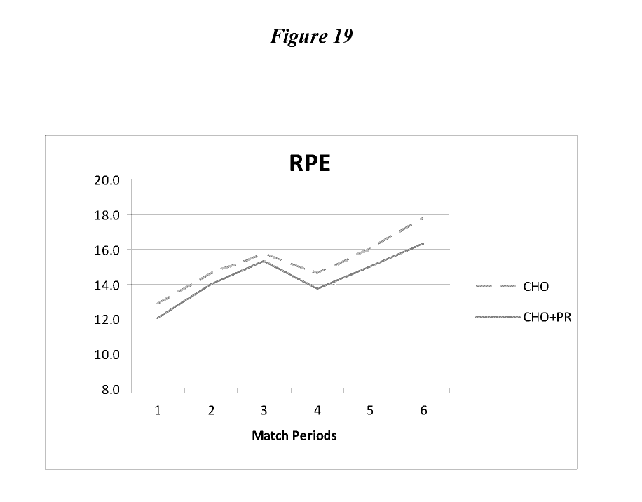

As shown in FIG. 18, sprint times were lower in subjects consuming the performance formulation. This indicates that consumption of a beverage with an optimized ratio of carbohydrates to protein, as according to several embodiments disclosed herein, increases the ability of a subject to perform an all out physical effort, even after an extended duration of physical activity occurs in between the efforts. Moreover, the ability to sprint a given distance in a lesser time was achieved with a lesser perceived exertion in those subjects consuming the performance formulation. See FIG. 19.

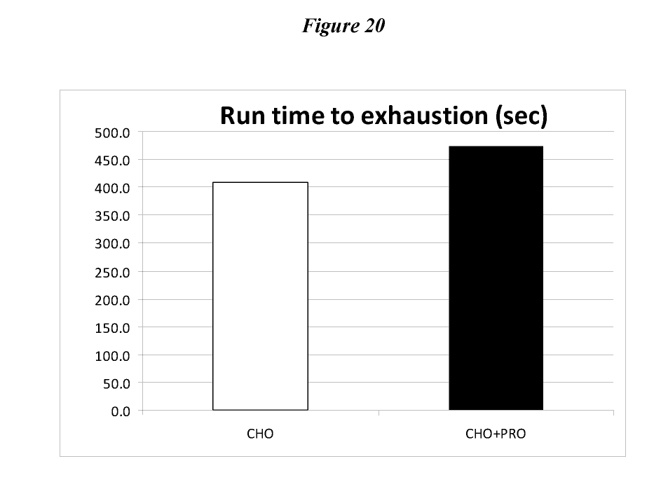

As depicted in FIG. 20, subjects consuming the performance formulation appear to have a greater time to exhaustion after the conclusion of the “match”. These initial data provide evidence that the conclusions discussed above related to the benefits of the performance formulation in the cycling context are also applicable to other athletic pursuits. Moreover, in several embodiments, the performance formulation is beneficial to providing additional energy and endurance during non-athletic pursuits, e.g., on-the-job exertion as experienced by firefighters, military personnel, labor workers, and the like.

Various modifications and applications of embodiments of the invention may be performed without departing from the true spirit or scope of the invention. Method steps disclosed herein need not be performed in the order set forth. It should be understood that the invention is not limited to the embodiments set forth herein for purposes of exemplification, but is to be defined only by a reading of the appended claims, including the full range of equivalency to which each element thereof is entitled.

What is claimed is:

1. An endurance-enhancing formulation to enhance performance during a physical activity that occurs at an intensity about or below a ventilatory threshold of a subject, said formulation comprising:
one or more carbohydrates; and
one or more proteins,
wherein the ratio of said carbohydrates to said proteins is 2.4:1 to 2.7:1,
wherein said one or more carbohydrates comprise dextrose, fructose and maltodextrin,
wherein said one or more proteins comprises whey protein, and
wherein said formulation is suitable for oral consumption and adapted to enhance performance during a physical activity that occurs at an intensity about or below a ventilatory threshold of said subject.

2. The endurance-enhancing formulation of claim 1, wherein said formulation is in a form selected from the group consisting of a liquid form, a powdered form, a gel form, and a chewable form.

3. The formulation of claim 1, wherein said formulation further comprises a flavorant.

4. The formulation of claim 1,
wherein said formulation is in liquid form,
wherein said one or more carbohydrates are present in a total concentration of less than about 4.5 grams per 100 mL of said liquid form,
and wherein said one or more proteins is present with a total concentration of less than about 1.5 grams per 100 mL of said liquid.

5. The formulation of claim 4, wherein said formulation provides about 17 calories in each 100 mL of the formulation.

6. The formulation of claim 4,
wherein said dextrose has a concentration in the range of about 0.8-1.5 grams per 100 mL;
wherein said maltodextrin has a concentration in the range of about 0.8-1.5 grams per 100 mL; and
wherein said fructose has a concentration in the range of about 0.8-1.5 grams per 100 mL.

7. The formulation of claim 1, wherein consumption of said formulation before or during physical activity enhances endurance by at least about 10% as compared to consumption of a carbohydrate-only formulation or by at least about 20% as compared to consumption of a carbohydrate and protein formulation with a carbohydrate to protein ratio of greater than 2.8:1.

8. The formulation of claim 1, wherein said formulation is free from at least one of the following ingredients: caffeine, lactose, and gluten.

9. The formulation of claim 1, wherein said formulation further comprises one or more of sodium, magnesium, potassium, and vitamin C.

10. The formulation of claim 1, wherein consumption of the formulation before or during physical activity regulates muscle glucose uptake and spares endogenous carbohydrate stores.

11. The formulation of claim 1, wherein consumption of the formulation before or during physical activity increases the time to exhaustion during said physical activity.

12. The formulation of claim 11, wherein said increase in the time to exhaustion is achieved without an increased in perceived exertion during said physical activity.

13. The formulation of claim 1, wherein consumption of the formulation before or during physical activity results in one or more of suppression of cortisol release, suppression of catecholamine release, suppression of cytokine release, an enhanced rate of protein synthesis, and an enhanced rate of training adaptation.

14. A recovery formulation to enhance recovery after physical activity comprising:
one or more carbohydrates;
one or more proteins; and
vitamin C having a concentration of up to about 1000 mg/100 ml;
wherein the ratio of said carbohydrates to said proteins is 2.4:1 to 2.7:1,
wherein said one or more carbohydrates comprise dextrose, fructose and maltodextrin,
wherein said one or more proteins comprises whey protein, and
wherein the formulation is suitable for oral consumption and is adapted to increase muscle glucose uptake and reduce muscle protein breakdown.

15. The recovery formulation of claim 14, wherein said formulation is in a form selected from the group consisting of a liquid form, a powdered form, a gel form, and a chewable form.

16. The recovery formulation of claim 14, wherein said dextrose, maltodextrin, and fructose in are present in a total a concentration of about 10-16 grams per 100 mL and wherein said whey protein is present in a total concentration of about 4-7 grams per 100 mL.

17. The recovery formulation of claim 14, further comprising:
sodium having a concentration of about 70 milligrams per 100 mL;
magnesium having a concentration of about 80 milligrams per 100 mL;
potassium having a concentration of about 30 milligrams per 100 mL;
iron having a concentration of about 2% of daily recommended intake;
a flavorant; and
about 100 mL water.

18. The recovery formulation of claim 14, wherein consumption of the formulation within about forty-five minutes post-activity increases muscle glucose uptake and reduces muscle protein breakdown.

19. A method of increasing the endurance of a subject during physical activity that occurs at or below the ventilatory threshold of the subject comprising consuming a formulation comprising:
one or more carbohydrates;
one or more proteins,
wherein the ratio of said carbohydrates to said proteins is 2.4:1 to 2.7:1,
wherein said one or more carbohydrates comprise dextrose, fructose and maltodextrin,
wherein said one or more proteins comprises whey protein, and
wherein said formulation is suitable for oral consumption.

20. The method of claim 19, wherein consumption of said formulation before or during said exercise spares endogenous carbohydrate stores, thereby increasing the subject's time to exhaustion and thereby enhancing endurance of said subject.
